(19) United States
(12) Patent Application Publication
(10) Pub. No.: US 2014/0030511 A1
(43) Pub. Date: Jan. 30, 2014

(54) PRESSURE-SENSITIVE ADHESIVE SHEET

(71) Applicants: Tatsumi Amano, Ibaraki-shi (JP); Yu Morimoto, Ibaraki-shi (JP); Kazuma Mitsui, Ibaraki-shi (JP); Kyoko Takashima, Ibaraki-shi (JP)

(72) Inventors: Tatsumi Amano, Ibaraki-shi (JP); Yu Morimoto, Ibaraki-shi (JP); Kazuma Mitsui, Ibaraki-shi (JP); Kyoko Takashima, Ibaraki-shi (JP)

(73) Assignee: NITTO DENKO CORPORATION, Ibaraki-shi (JP)

(21) Appl. No.: 14/111,298

(22) PCT Filed: Apr. 6, 2012
(86) PCT No.: PCT/JP2012/059524

§ 371 Date: Oct. 11, 2013

(30) Foreign Application Priority Data
Apr. 15, 2011 (JP) 2011-091485
Apr. 15, 2011 (JP) 2011-091503
Apr. 15, 2011 (JP) 2011-091509

(51) Int. Cl. C09J 7/02

(52) U.S. Cl. CPC C09J 7/0296; C09J 7/0246
USPC 428/336

(57) ABSTRACT

Disclosed is a pressure-sensitive adhesive sheet that has a transparent film substrate and, on at least one side thereof, an acrylic pressure-sensitive adhesive layer. The transparent film substrate has a top coat layer having a specific configuration with an average thickness and a thickness variation being controlled. The acrylic pressure-sensitive adhesive layer is formed from a water-dispersible acrylic pressure-sensitive adhesive composition. The composition includes, as components, an acrylic emulsion polymer derived from constitutive monomers in a specific formulation; a polyether compound having a specific structure; and a specific acetylenic diol. The pressure-sensitive adhesive sheet is found to be highly resistant to scratches and static electrification, to have superior visual quality and satisfactory resistance to adhesive strength increase, and to less cause stains.

### TECHNICAL FIELD

The present invention relates to removable pressure-sensitive adhesive sheets. Specifically, the present invention relates to a removable pressure-sensitive adhesive sheet that has superior visual quality, is satisfactorily resistant to adhesive strength increase with time, and has less stains, scratch resistance and antistatic properties at satisfactory levels.

### BACKGROUND ART

Optical members (optical materials) may be represented by optical films such as polarizing plates, retardation films, and anti-reflective films. In production or working processes of them, surface-protecting films are laminated on the surface of the optical members for the purpose typically of preventing surface flaws and stains, improving cutting workability, or suppressing cracking (see Patent Literature (PTL) 1 and 2). Removable pressure-sensitive adhesive sheets are generally used as the surface-protecting films. The removable pressure-sensitive adhesive sheets each include a plastic film substrate and, on a surface thereof, a removable pressure-sensitive adhesive layer.

For the surface-protecting films, solvent-borne acrylic pressure-sensitive adhesives have been used as pressure-sensitive adhesives to form the pressure-sensitive adhesive layer (see PTL 1 and 2). These solvent-borne acrylic pressure-sensitive adhesives contain organic solvents that may adversely affect the coating working environment. To prevent the adverse effect, attempts have been made to substitute water-dispersible acrylic pressure-sensitive adhesives for the solvent-borne acrylic pressure-sensitive adhesives (see PTL 3 to 5).

Such surface-protecting films should exhibit sufficient adhesiveness during affixation to the optical member. They should also have excellent removability because they will be removed after usage typically in production processes to give optical members. To have excellent removability, the surface-protecting films require not only small release force (easiness to release), but also such a property as to be resistant to increase in adhesive strength (release force) with time after the application to an adherend such as an optical member. This property is also referred to as “resistance to adhesive strength increase.”

To obtain the properties such as easiness to release and resistance to adhesive strength increase, a water-insoluble crosslinking agent is effectively used in a pressure-sensitive adhesive (or in a pressure-sensitive adhesive composition) to form a pressure-sensitive adhesive layer. Exemplary known pressure-sensitive adhesive compositions using a water-insoluble crosslinking agent include water-dispersible removable acrylic pressure-sensitive adhesive compositions containing an oil-soluble crosslinking agent (see PTL 6 and 7).

However, water-dispersible acrylic pressure-sensitive adhesive compositions using a water-insoluble crosslinking agent as with the above-mentioned pressure-sensitive adhesive compositions often suffer from visual defects such as “dimples” on the pressure-sensitive adhesive layer surface, in which the defects occur during the formation of the pressure-sensitive adhesive layer. This is because large particles of the water-insoluble crosslinking agent remain without sufficient dispersion in the pressure-sensitive adhesive composition and cause the visual defects. The water-insoluble crosslinking agent, particularly when used to form a pressure-sensitive adhesive layer of a surface-protecting film, may therefore disadvantageously impede, for example, the inspection of the adherend with the surface-protecting film.

Accordingly, no pressure-sensitive adhesive sheet has been obtained under present circumstances, which pressure-sensitive adhesive sheet has a pressure-sensitive adhesive layer having adhesiveness and removability (particularly resistance to adhesive strength increase) at satisfactory levels, less suffering from visual defects such as “dimples”, and having superior visual quality.

A water-dispersible acrylic pressure-sensitive adhesive composition contains a surfactant component for stable water dispersibility, and this disadvantageously causes the pressure-sensitive adhesive composition to readily bubble (foam). The pressure-sensitive adhesive composition, particularly during a stirring process, disadvantageously readily involves air as bubbles, and the involved bubbles are stabilized by the surfactant and hardly escape from the composition. The bubbles may remain in the resulting pressure-sensitive adhesive layer upon the formation of the layer or may form visual defects such as “dimples” in the pressure-sensitive adhesive layer surface.

For this reason, the pressure-sensitive adhesive layer, particularly when used as a pressure-sensitive adhesive layer of a surface-protecting film, may disadvantageously impede, for example, the inspection of the adherend with the surface-protecting film.

Especially as a surface-protecting film (particularly as a surface-protecting film for an optical member), strong demands have been made to provide a surface-protecting film having no defect derived from bubbles. This is because, if the surface-protecting film has bubbles remained in the pressure-sensitive adhesive layer and/or has “dimples” present in the pressure-sensitive adhesive layer surface, it is difficult to determine whether the bubbles and/or the “dimples” are defects of a member to be applied (e.g., an adherend optical member) or the defects of the surface-protecting film itself; and this may impede the quality inspection and quality control.

A technique of adding an antifoaming agent has been known to reduce or mitigate the bubble-derived defects. Silicone antifoaming agents and hydrophobic-silica-containing antifoaming agents are known as the antifoaming agent for their satisfactory defoaming activities (see PTL 8 and 9).

The silicone antifoaming agents, however, are not uniformly dispersible in the pressure-sensitive adhesive composition, locally form regions with high hydrophobicity, and thereby disadvantageously cause crawling upon application of the pressure-sensitive adhesive composition. In addition, the silicone antifoaming agents have poor compatibility with an acrylic emulsion polymer, thereby bleed out to the pressure-sensitive adhesive layer surface after layer formation, and disadvantageously stain the adherend. This becomes significant in a surface-protecting film for an optical member because the contaminant (stain) can affect the optical properties of the optical member. In contrast, the hydrophobic-silica-containing antifoaming agents disadvantageously cause defects derived from the silica particles formed as secondary aggregates of the contained hydrophobic silica, although being uniformly dispersible in the pressure-sensitive adhesive composition. The pressure-sensitive adhesive composition, when used to form a surface-protecting film for an optical member, is generally filtrated typically through a filter. This is because foreign matter, if present in the pressure-sensitive adhesive composition, forms or causes optical defects. When the composition contains silica particles as above, the filter is clogged with the silica particles, and this disadvantageously reduces the production efficiency.

In a use typically as a surface-protecting film (particularly as a surface-protecting film for an optical member), stains on the adherend surface disadvantageously adversely affect the optical properties of the optical member. The stains are caused typically by so-called “adhesive residue” where the pressure-sensitive adhesive remains on the adherend (e.g., optical member) surface after the pressure-sensitive adhesive sheet is removed. The stains are also caused by the transfer (migration) of a component from the pressure-sensitive adhesive layer to the adherend surface. To prevent these, strong demands are made on the pressure-sensitive adhesive and the pressure-sensitive adhesive layer to less stain the adherend.

### CITATION LIST

### Patent Literature

PTL 1: Japanese Unexamined Patent Application Publication (JP-A) No. H11-961
PTL 2: JP-A No. 2001-64607
PTL 3: JP-A No. 2001-131512
PTL 4: JP-A No. 2003-27026
PTL 5: Japanese Patent No. 3810490
PTL 6: JP-A No. 2004-91563
PTL 7: JP-A No. 2006-169496
PTL 8: JP-A No. H08-34963
PTL 9: JP-A No. 2005-279565

### SUMMARY OF INVENTION

### Technical Problem

When a pressure-sensitive adhesive sheet is used as a surface-protecting film, the surface-protecting film requires such a property as to be resistant to scratches on the surface (substrate surface). This property is hereinafter also referred to as “scratch resistance.” This is because, if scratches are present in the surface (substrate surface) of the surface-protecting film, it is difficult to determine whether any scratches are derived from the surface-protecting film or from the adherend (e.g., optical member) to be visually inspected. An exemplary technique for better scratch resistance of a backside of a surface-protecting film is a technique of providing a hard surface layer (top coat layer) on the backside of the surface-protecting film. The “backside” herein refers to a surface (substrate side surface) of the surface-protecting film, namely, the opposite side to a surface (a pressure-sensitive adhesive layer surface) to be applied to the adherend.

However, the surface-protecting film bearing the top coat layer on the backside thereof, when applied to an adherend and is observed as intact from the backside, appears cloudy wholly or partially, and this disadvantageously causes poor visibility of the adherend surface. The observation is performed typically in a bright room admitting outside light, or under a fluorescent lamp in a bright room. In addition, the top coat layer, if having a variation or deviation in thickness, suffers from a difference in reflectance from one region to another and appears relatively cloudy in a thick region. This disadvantageously causes further poorer visibility of the adherend surface.

To prevent this, a demand has been made to provide a surface-protecting film that has a top coat layer having superior scratch resistance on a backside (substrate surface) thereof, less appears cloudy wholly or partially, and exhibits a good appearance.

Surface-protecting films, particularly when used typically in working or transportation processes of static-sensitive products such as liquid crystal cells and semiconductor devices, require such properties as to be resistant to static electrification (antistatic properties).

Accordingly, an object of the present invention is to provide a pressure-sensitive adhesive sheet as follows. The pressure-sensitive adhesive sheet has a transparent film substrate having a top coat layer, and an acrylic pressure-sensitive adhesive layer on at least one side of the transparent film substrate; has superior visual quality, is highly resistant to adhesive strength increase with time, less causes stains, is satisfactorily resistant to scratches and static electrification, and is removable. The superior “visual quality” refers to that the pressure-sensitive adhesive sheet less suffers from visual defects, such as dimples and bubble defects, in the pressure-sensitive adhesive layer and less appears cloudy.

### Solution to Problem

After intensive investigations to achieve the object, the present inventors have found that a specific pressure-sensitive adhesive sheet is highly resistant to scratches and static electrification, has superior visual quality, is satisfactorily resistant to adhesive strength increase, and less causes stains (has less-staining properties); in which the pressure-sensitive adhesive sheet has a transparent film substrate and, on at least one side thereof, an acrylic pressure-sensitive adhesive layer; the transparent film substrate has a top coat layer of a specific configuration with an average thickness and a thickness variation being controlled; and the acrylic pressure-sensitive adhesive layer is formed from a water-dispersible acrylic pressure-sensitive adhesive composition including, as components, an acrylic emulsion polymer obtained from constitutive monomers in a specific formulation, a polyether compound having a specific structure, and a specific acetylenic diol. The present invention has been made based on these findings.

Specifically, the present invention provides a pressure-sensitive adhesive sheet that includes a transparent film substrate; and an acrylic pressure-sensitive adhesive layer present on or above at least one side of the transparent film substrate, in which the transparent film substrate includes a base layer formed from a resinous material; and a top coat layer present on or above a first face of the base layer; the top coat layer includes a polythiophene, an acrylic resin, and a melamine crosslinking agent and has an average thickness Dₐᵥₑ of from 2 to 50 nm and a thickness variation ΔD of 40% or less; the acrylic pressure-sensitive adhesive layer is formed from a water-dispersible removable acrylic pressure-sensitive adhesive composition, where the water-dispersible removable acrylic pressure-sensitive adhesive composition includes: an acrylic emulsion polymer (A); a compound (B) represented by Formula (I); and an acetylenic diol compound (C) having a HLB value of less than 13; the acrylic emulsion polymer (A) is derived from constitutive monomers including a (meth)acrylic alkyl ester and a carboxyl-containing unsaturated monomer as essential constitutive monomers, where the constitutive monomers include the (meth)acrylic alkyl ester in a content of from 70 to 99.5 percent by Weight and the carboxyl-containing unsaturated monomer in a content of from 0.5 to 10 percent by weight based on the total amount of the constitutive monomers; and the acrylic emulsion polymer (A) is polymerized with a reactive emulsifier containing at least one radically polymerizable functional group per molecule, Formula (I) is expressed as follows:

R^{a}O—(PO)₁-(EO)ₘ—(PO)ₙ—R^{b} (I)

wherein each of R^{a} and R^{b} independently represents a straight or branched chain alkyl group or hydrogen atom; PO represents oxypropylene group; EO represents oxyethylene group; and each of l, m, and n independently denotes a positive integer, where EO(s) and POs are added in a block manner.

The resinous material constituting the base layer may include a poly(ethylene terephthalate) or a poly(ethylene naphthalate) as a principal resinous component.

The water-dispersible removable acrylic pressure-sensitive adhesive composition may further include a water-insoluble crosslinking agent (D) having two or more carboxyl-reactive functional groups per molecule, where the carboxyl-reactive functional groups are capable of reacting with carboxyl group.

The pressure-sensitive adhesive sheet may serve as a surface-protecting film for an optical member.

### Advantageous Effects of Invention

The pressure-sensitive adhesive sheet according to the present invention, as having the transparent film substrate, is highly resistant to scratches and static electrification and less appears cloudy as a whole. The pressure-sensitive adhesive sheet according to the present invention, as having the acrylic pressure-sensitive adhesive layer, less suffers from visual defects such as dimples and bubble defects, has good removability and adhesiveness, and is resistant to increase in adhesive strength to an adherend with time. The pressure-sensitive adhesive sheet minimally causes stains on the adherend surface after its removal and exhibits satisfactory less-staining properties. The pressure-sensitive adhesive sheet according to the present invention, as having the configuration as described above, has particularly superior visual quality, allows easy visual inspection of the adherend (e.g., optical member) with the pressure-sensitive adhesive sheet, and contributes to better inspection accuracy. For these reasons, the pressure-sensitive adhesive sheet according to the present invention is useful particularly for the surface protection of an optical film.

### DESCRIPTION OF EMBODIMENTS

A pressure-sensitive adhesive sheet according to an embodiment of the present invention has a transparent film substrate and, present on at least one side thereof, an acrylic pressure-sensitive adhesive layer. As used herein the term “pressure-sensitive adhesive sheet” also refers to and includes one in a tape form, i.e., a “pressure-sensitive adhesive tape.” A surface of the acrylic pressure-sensitive adhesive layer of the pressure-sensitive adhesive sheet according to the present invention is also referred to as an “adhesive face.”

The pressure-sensitive adhesive sheet according to the present invention may be a double-coated pressure-sensitive adhesive sheet having adhesive faces as both surfaces, or a single-coated pressure-sensitive adhesive sheet having an adhesive face as only one surface. Above all, the pressure-sensitive adhesive sheet is preferably a single-coated pressure-sensitive adhesive sheet for the surface protection of the adherend. Specifically, the pressure-sensitive adhesive sheet according to the present invention is preferably a pressure-sensitive adhesive sheet (single-coated pressure-sensitive adhesive sheet) having a transparent film substrate and, on one side thereof, an acrylic pressure-sensitive adhesive layer. Particularly from the viewpoint of the scratch resistance, a surface of the transparent film substrate opposite to the acrylic pressure-sensitive adhesive layer preferably serves as the top coat layer surface in the pressure-sensitive adhesive sheet (single-coated pressure-sensitive adhesive sheet).

Transparent Film Substrate

The transparent film substrate in the pressure-sensitive adhesive sheet according to the present invention has at least a base layer made from a resinous material; and an after-mentioned top coat layer provided on or over a first face of the base layer. The transparent film substrate may have a structure (layered structure) having the top coat layer on only one side (first face) of the base layer; or a structure (layered structure) having the top coat layer on both sides (first face and second face) of the base layer. Above all, the transparent film substrate preferably has the top coat layer on only one side (first face) of the base layer.

Base Layer

The base layer in the transparent film substrate is a molded article in the form of a film (thin film) made from a resinous material. Specifically, the base layer is preferably any of resin films prepared by molding various resinous materials into films. The resinous material constituting the base layer is not limited, but is preferably such a resinous material as to give a resin film excellent in one or more of properties such as transparency, mechanical strength, thermal stability, water shielding properties, and isotropy. Specifically, the resinous material is preferably one containing, as a principal component (resinous component), any polyer selected typically from polyester polymers such as poly(ethylene terephthalate)s (PETs), poly(ethylene naphthalate)s, and poly(butylene terephthalate)s; cellulosic polymers such as diacetyl cellulose and triacetyl cellulose; polycarbonate polymers; and acrylic polymers such as poly(methyl methacrylate)s. The principal component refers to a principal component of the resinous material, such as a component that constitutes 50 percent by weight or more of the total weight (100 percent by weight) of the resinous material. The resinous material is more preferably one containing a poly(ethylene terephthalate) or a poly(ethylene naphthalate) as a principal component. Exemplary components of the resinous material further include styrenic polymers such as polystyrenes and acrylonitrile-styrene copolymers; olefinic polymers such as polyethylenes, polypropylenes, polyolefins each having a cyclic or norbornene structure, and ethylene-propylene copolymers; vinyl chloride polymers; amide polymers such as nylon 6, nylon 6,6, and aromatic polyamides; imide polymers; sulfonic polymers; poly(ether sulfone) polymers; poly(ether ether ketone) polymers; poly(phenylene sulfide) polymers; poly(vinyl alcohol) polymers; polyoxymethylene polymers; and epoxy polymers. The base layer may be formed from a blend of two or more of the resinous materials. The base layer preferably has smaller anisotropy in optical properties such as phase difference. It is advantageous to reduce the optical anisotropy of the base layer particularly when the pressure-sensitive adhesive sheet is used as a surface-protecting film for an optical member. The base layer may have a single-layer structure, or a multilayer structure including two or more layers having different compositions (formulations). The base layer particularly preferably has a single-layer structure.

Where necessary, the base layer may contain any of additives such as antioxidants, ultraviolet absorbers, antistatic components, plasticizers, and colorants (e.g., pigments and dyestuffs).

The first face (the surface on which a top coat layer is to be provided) of the base layer may have been subjected to any of known or customary surface treatments such as corona discharge treatment, plasma treatment, ultraviolet irradiation, acid treatment, base treatment, and primer coating. The surface treatment is performed typically for better adhesion between the base layer and the top coat layer. Among them, preferably employed is such a surface treatment as to introduce a polar group, such as hydroxyl group (—OH group), into the first face of the base layer.

The second face (generally, the surface on which an acrylic pressure-sensitive adhesive layer is to be formed) of the base layer may also have been subjected to a surface treatment as above. The surface treatment is performed typically for better adhesion between the transparent film substrate and the acrylic pressure-sensitive adhesive layer (for better anchoring capability of the acrylic pressure-sensitive adhesive layer).

The base layer may have any thickness suitably selectable according to the intended use and purpose, but has a thickness of preferably from 10 to 200 μm, more preferably from 15 to 100 μm, and furthermore preferably from 20 to 70 μm. This range is preferred for good balance of strength and workability (e.g., handleability) with other conditions or properties such as cost and facilitation of visual inspection.

The base layer may have a refractive index not critical, but preferably from 1.43 to 1.6 and more preferably from 1.45 to 1.5 from the viewpoint of the visual quality.

The base layer may have a total luminous transmittance in the visible light region not critical, but, from the viewpoint of the visual quality, preferably from 80% to 97% and more preferably from 85% to 95% as determined according to JIS K7361-1.

The base layer may have an arithmetic mean surface roughness (Ra) not critical, but preferably from 0.001 to 1 μm and more preferably from 0.01 to 0.7 μm on the second face. The second face is generally the surface on which an acrylic pressure-sensitive adhesive layer is to be formed. The base layer, if having an arithmetic mean surface roughness on the second face of more than 1 μm, may cause poor thickness accuracy of the coated surface (adhesive face) of the acrylic pressure-sensitive adhesive layer. The base layer in this case may also cause insufficient anchoring capability of the acrylic pressure-sensitive adhesive layer with respect to the transparent film substrate, because the pressure-sensitive adhesive fails to migrate into space between the surface asperities of the transparent film substrate, resulting in a smaller contact area between the acrylic pressure-sensitive adhesive layer and the transparent film substrate. These are because the acrylic pressure-sensitive adhesive layer in the pressure-sensitive adhesive sheet according to the present invention has a high solvent-insoluble content. In contrast, the base layer, if having an arithmetic mean surface roughness of less than 0.001 μm, may become susceptible to blocking and/or have insufficient handleability, and this may impede industrial production.

Top Coat Layer

The top coat layer in the transparent film substrate of the pressure-sensitive adhesive sheet according to the present invention is a surface layer formed on at least the first face of the base layer and is derived from at least a polythiophene, an acrylic resin, and a melamine crosslinking agent as essential components. The presence of the top coat layer allows the pressure-sensitive adhesive sheet according to the present invention to exhibit not only scratch resistance and antistatic properties, but also various functions such as solvent resistance, printability, and ink adhesion. The pressure-sensitive adhesive sheet according to the present invention, when having any of the functions, is preferably usable particularly for the surface protection of an optical film.

The acrylic resin in the top coat layer is a basic component (base resin) contributing to the formation of the top coat layer and is a resin containing an acrylic polymer as a base polymer. The term “base polymer” refers to a principal component among polymer components, namely, a component constituting 50 percent by weight or more of the polymer components. Specifically, the acrylic resin may contain the acrylic polymer in a content of 50 percent by weight or more (e.g., from 50 to 100 percent by weight), preferably from 70 to 100 percent by weight, and more preferably from 90 to 100 percent by weight, based on the total weight (100 percent by weight) of the acrylic resin.

As used herein the term “acrylic polymer” refers to a polymer containing a monomer having at least one (meth)acryloyl group per molecule (in molecule) as a principal monomer component. This monomer is hereinafter also referred to as an “acrylic monomer.” Specifically, monomer components constituting the acrylic polymer contain the acrylic monomer or monomers in a content of 50 percent by weight or more based on the total weight (100 percent by weight) of the monomer components. As used herein the term “(meth)acryloyl group” refers to acryloyl group and/or methacryloyl group (either one or both of acryloyl group and methacryloyl group).

The acrylic resin is exemplified by, but not limited to, acrylic resins of various types, such as thermosetting acrylic resins, ultraviolet-curable acrylic resins, electron-beam-curable acrylic resins, and two-component acrylic resins. Each of different acrylic resins may be used alone or in combination. Among them, preferably selected is an acrylic resin capable of forming a top coat layer that is highly resistant to scratches (e.g., is evaluated as good in scratch resistance evaluation in after-mentioned “Evaluations”) and transmits light satisfactorily. The acrylic resin in the top coat layer can be grasped also as a binder (binder resin) for the polythiophene (antistatic component).

The acrylic polymer serving as a base polymer of the acrylic resin is not limited, but is preferably an acrylic polymer containing methyl methacrylate (MMA) as a principal monomer component (monomeric component) and is more preferably a copolymer of methyl methacrylate with one or more other monomers. The other monomers are preferably acrylic monomers other than methyl methacrylate. Methyl methacrylate may be copolymerized to form the acrylic polymer in an amount not critical, but preferably 50 percent by weight or more (e.g., from 50 to 90 percent by weight) and more preferably 60 percent by weight or more (e.g., from 60 to 85 percent by weight) based on the total weight (100 percent by weight) of entire monomer components constituting the acrylic polymer.

The monomers to be copolymerized with methyl methacrylate to form the acrylic polymer are exemplified by, but not limited to, (meth)acrylic alkyl esters other than methyl methacrylate, of which preferably exemplified are (meth)acrylic alkyl esters having a straight or branched chain alkyl group; and (meth)acrylic alkyl esters (cycloalkyl (meth)acrylates) having an alicyclic alkyl group (cycloalkyl group).

The (meth)acrylic alkyl esters having a straight or branched chain alkyl group are exemplified by, but not limited to, alkyl acrylates (acrylic alkyl esters) with alkyl moiety having 1 to 12 carbon atoms, such as methyl acrylate, ethyl acrylate, n-butyl acrylate (BA), and 2-ethylhexyl acrylate (2EHA); and alkyl methacrylates (methacrylic alkyl esters) with alkyl moiety having 2 to 6 carbon atoms, such as ethyl methacrylate, isopropyl methacrylate, n-butyl methacrylate, and isobutyl methacrylate. The (meth)acrylic alkyl esters having an alicyclic alkyl group are exemplified by, but not limited to, cycloalkyl acrylates with cycloalkyl moiety having 5 to 7 carbon atoms, such as cyclopentyl acrylate and cyclohexyl acrylate; and cycloalkyl methacrylates with cycloalkyl moiety having 5 to 7 carbon atoms, such as cyclopentyl methacrylate and cyclohexyl methacrylate (CHMA).

In a preferred embodiment, the acrylic polymer is an acrylic polymer derived from monomer components including at least methyl methacrylate (MMA) and cyclohexyl methacrylate (CHMA). In this embodiment, cyclohexyl methacrylate may be copolymerized in a percentage not critical, but typically preferably 25 percent by weight or less (e.g., from 0.1 to 25 percent by weight) and more preferably 15 percent by weight or less (e.g., from 0.1 to 15 percent by weight) based on the total weight (100 percent by weight) of entire monomer components constituting the acrylic polymer.

In another preferred embodiment, the acrylic polymer is an acrylic polymer derived from monomer components including at least methyl methacrylate (MMA) and at least one of n-butyl acrylate (BA) and 2-ethylhexyl acrylate (2EHA). In this embodiment, at least one of n-butyl acrylate and 2-ethylhexyl acrylate may be copolymerized in a percentage (total percentage when the two monomers are copolymerized) not critical, but typically preferably 40 percent by weight or less (e.g., from 1 to 40 percent by weight), more preferably from 10 to 40 percent by weight, furthermore preferably from 30 percent by weight or less (e.g., from 3 to 30 percent by weight), and particularly preferably from 15 to 30 percent by weight, based on the total weight (100 percent by weight) of the monomer components constituting the acrylic polymer.

In a particularly preferred embodiment, the acrylic polymer is an acrylic polymer derived from monomer components substantially including methyl methacrylate, cyclohexyl methacrylate, and at least one of n-butyl acrylate and 2-ethylhexyl acrylate. Specifically, preferred is an acrylic polymer derived from monomer components including methyl methacrylate, cyclohexyl methacrylate, and at least one of n-butyl acrylate and 2-ethylhexyl acrylate in an total amount (total content) of 52 percent by weight or more based on the total weight (100 percent by weight) of the monomer components constituting the acrylic polymer.

Any of other monomers may be copolymerized with the aforementioned monomers to form the acrylic polymer within ranges not significantly adversely affecting advantageous effects of the present invention. The other monomers are exemplified by carboxyl-containing monomers such as acrylic acid, methacrylic acid, itaconic acid, maleic acid, and fumaric acid; acid-anhydride-containing monomers such as maleic anhydride and itaconic anhydride; vinyl esters such as vinyl acetate and vinyl propionate; aromatic vinyl compounds such as styrene and α-methylstyrene; amido-containing monomers such as acrylamide and N,N-dimethylacrylamide; amino-containing monomers such as aminoethyl (meth)acrylate and N,N-dimethylaminoethyl (meth)acrylate; imido-containing monomers such as cyclohexylmaleimide; epoxy-containing monomers such as glycidyl (meth)acrylate; (meth)acryloylmorpholine; vinyl ethers such as methyl vinyl ether; and hydroxyl-containing monomers such as hydroxyethyl (meth)acrylate, hydroxypropyl (meth)acrylate, hydroxybutyl (meth)acrylate, hydroxypentyl (meth)acrylate, hydroxyhexyl (meth)acrylate, hydroxyoctyl (meth)acrylate, hydroxydecyl (meth)acrylate, hydroxylauryl (meth)acrylate, (4-hydroxymethylcyclohexyl)methyl acrylate, N-methylol(meth)acrylamide, vinyl alcohol, allyl alcohol, hydroxyethyl vinyl ether, hydroxybutyl vinyl ether, and diethylene glycol monovinyl ether. Such “other monomers” may be copolymerized in a percentage (in a total percentage when two or more different other monomers are used) not critical, but preferably 20 percent by weight or less, more preferably 10 percent by weight or less, furthermore preferably 5 percent by weight or less, and most preferably 3 percent by weight or less. The monomer components to form the acrylic polymer may include substantially no “other monomers” to be copolymerized. Typically, the acrylic polymer may have a content of other monomers of 0.1 percent by weight or less based on the total weight (100 percent by weight) of entire monomers constituting the acrylic polymer.

The acrylic polymer is preferably derived from copolymerization components including substantially no monomers containing an acidic functional group (acidic-functional-group-containing monomers; such as acrylic acid and methacrylic acid). Specifically, the acrylic polymer preferably has a content of acidic-functional-group-containing monomers of 0.1 percent by weight or less based on the total amount of the monomer components. The top coat layer, when employing a melamine crosslinking agent in combination with the acrylic polymer including substantially no acidic-functional-group-containing monomer as components, can readily have higher hardness and exhibit better adhesion to the base layer. As used herein the term “acidic functional group” refers to a functional group capable of becoming acidic, such as carboxyl group or acid anhydride group. The same is true for the following description.

The acrylic polymer is preferably derived from copolymerization components including a monomer having at least one hydroxyl group (hydroxyl-containing monomer). The hydroxyl-containing monomer, when copolymerized, helps the top coat layer to exhibit better adhesion to the base layer.

The acrylic resin constituting the top coat layer may further contain one or more other resinous components (except polythiophenes) in addition to the acrylic polymer. The acrylic resin should have a content of the other resinous components of less than 50 percent by weight based on the total weight (100 percent by weight) of the acrylic resin.

The polythiophene in the top coat layer serves as a component (antistatic component) having the function of preventing static electrification of the pressure-sensitive adhesive sheet according to the present invention. The pressure-sensitive adhesive sheet according to the present invention, as including the polythiophene in the top coat layer, is highly resistant to static electrification and is particularly preferably usable as a surface-protecting film for use typically in a working or transportation process of static-sensitive articles such as liquid crystal cells and semiconductor devices.

In addition, the polythiophene is highly hydrophobic, less absorbs moisture even in a high-humidity environment (under humid conditions), and less causes clouding of the transparent film substrate (more specifically, hygroscopic clouding of the top coat layer). By contrast, a hygroscopic substance (e.g., an ammonium salt), if employed as an antistatic component in the top coat layer, may often cause clouding of the substrate in a high-humidity environment (more specifically, hygroscopic clouding of the top coat layer).

Examples of the polythiophene include not only polymers of unsubstituted thiophene, but also polymers of substituted thiophenes such as 3,4-ethylenedioxythiophene. Among them, the polythiophene is preferably a polymer of 3,4-ethylenedioxythiophene, i.e., a poly(3,4-ethylenedioxythiophene), for satisfactory antistatic properties.

The polythiophene may have a weight-average molecular weight (Mw) not critical, but preferably 40×10⁴ or less (e.g., from 0.1×10⁴ to 40×10⁴) and more preferably from 0.5×10⁴ to 30×10⁴ in terms of a polystyrene standard. The polythiophene, if having a weight-average molecular weight Mw of more than 40×10⁴, may suffer from insufficient compatibility to cause the pressure-sensitive adhesive sheet to have poor visual quality and/or insufficient solvent resistance in some combinations with other components constituting the top coat layer. In contrast, the polythiophene, if having a weight-average molecular weight Mw of less than 0.1×10⁴, may cause poor scratch resistance.

The polythiophene may be used in an amount (content in the top coat layer) not critical, but preferably from 10 to 200 parts by weight, more preferably from 25 to 150 parts by weight, and furthermore preferably from 40 to 120 parts by weight, per 100 parts by weight of the acrylic polymer in the top coat layer. The polythiophene, if used in an amount of less than 10 parts by weight, may cause the top coat layer side surface of the transparent film substrate to have an excessively high surface resistivity that is difficult to be controlled within a range mentioned later. In contrast, the polythiophene, if used in an amount of more than 200 parts by weight, may readily cause the top coat layer to have a large thickness variation ΔD and thereby cause the pressure-sensitive adhesive sheet to partially appear cloudy and to have inferior visual quality. The polythiophene in this case may also suffer from insufficient compatibility to cause the pressure-sensitive adhesive sheet to have poor visual quality and/or insufficient solvent resistance in some combinations with other components constituting the top coat layer.

In an embodiment, the top coat layer is formed by a process of applying a liquid composition (top coat layer coating composition) to the base layer surface, and drying or curing the applied composition, as mentioned later. In this embodiment, preferably employed to prepare the composition is a solution or dispersion of the polythiophene in water (an aqueous polythiophene solution or dispersion). The aqueous polythiophene solution or dispersion can be prepared by dissolving or dispersing a polythiophene having a hydrophilic functional group in water. The polythiophene just mentioned above can be synthetically prepared typically by a technique of copolymerizing a monomer having at least one hydrophilic functional group per molecule. The hydrophilic functional group is exemplified by sulfo group, amino group, amido group, imino group, hydroxyl group, mercapto group, hydrazino group, carboxyl group, quaternary ammonium group, sulfuric ester group (—O—SO₃H), and phosphoric ester groups (e.g., —O—PO(OH)₂). Each of these hydrophilic functional groups may form a salt. The aqueous polythiophene solution is also available as any of commercial products typically under the trade names of “Denatron” series (from Nagase ChemteX Corporation).

Of the aqueous polythiophene solutions, particularly preferred for stable antistatic properties is an aqueous polythiophene solution including a polystyrenesulfonate (PSS). In the aqueous polythiophene solution, a PSS can be present as a dopant doped to a polythiophene. The aqueous PSS-containing polythiophene solution may have a ratio of the polythiophene to the polystyrenesulfonate [polythiophene:polystyrenesulfonate] not critical, but preferably from 1:5 to 1:10. The aqueous PSS-containing polythiophene solution may contain the polythiophene and the polystyrenesulfonate in a total sum of contents (total content) not critical, but preferably from 1 to 5 percent by weight. The aqueous PSS-containing polythiophene solution is also available as any of commercial products typically under the trade name of “Baytron” (from H.C. Stark GmbH). The aqueous PSS-containing polythiophene solution, when used, may contain the polythiophene and the polystyrenesulfonate in a total amount not critical, but preferably from 10 to 200 parts by weight, more preferably from 25 to 150 parts by weight, and furthermore preferably from 40 to 120 parts by weight, per 100 parts by weight of the acrylic polymer in the top coat layer.

The top coat layer, as employing the acrylic base resin in combination with the antistatic component polythiophene, can give a transparent film substrate that has a low surface resistivity even when the top coat layer has a small thickness. A further better result is obtained particularly when employing, as the acrylic resin, an acrylic resin mainly including an acrylic polymer derived from copolymerization components containing substantially no acidic-functional-group-containing monomer.

The melamine crosslinking agent in the top coat layer plays a role of crosslinking the acrylic polymer and thereby allowing the acrylic polymer to exhibit at least one advantageous effect including better scratch resistance, better solvent resistance, better ink adhesion, and lower frictional coefficient, of which better scratch resistance is preferred. The melamine crosslinking agent is a compound having a melamine structure. The melamine crosslinking agent is exemplified by methylolmelamines such as monomethylolmelamine, dimethylolmelamine, trimethylolmelamine, tetramethylolmelamine, pentamethylolmelamine, and hexamethylolmelamine; and alkoxyalkylmelamines including alkoxymethylmelamines such as methoxymethylmelamine, ethoxymethylmelamine, propoxymethylmelamine, butoxymethylmelamine, hexa(methoxymethyl)melamine, hexa(ethoxymethyl)melamine, hexa(propoxymethyl)melamine, hexa(butoxymethyl)melamine, hexa(pentyloxymethyl)melamine, and hexa(hexyloxymethyl)melamine, as well as alkoxybutylmelamines such as methoxybutylmelamine, ethoxybutylmelamine, propoxybutylmelamine, and butoxybutylmelamine.

The melamine crosslinking agent is also available as commercial products typically under the trade names of “CYMEL 202”, “CYMEL 212”, “CYMEL 232”, “CYMEL 235”, “CYMEL 253”, “CYMEL 266”, “CYMEL 267”, “CYMEL 270”, “CYMEL 272”, “CYMEL 285”, “CYMEL 300”, “CYMEL 301”, “CYMEL 303”, “CYMEL 327”, “CYMEL 350”, “CYMEL 370”, “CYMEL 701”, “CYMEL 703”, and “CYMEL 771” (each from Cytec Industries Inc.); and under the trade names of “NIKALAC MW-30”, “NIKALAC MW-30M”, “NIKALAC MW-30HM”, “NIKALAC MW-45”, “NIKALAC MW-390”, “NIKALAC MX-270”, “NIKALAC MX-302”, “NIKALAC MX-706”, and “NIKALAC MX-750” (each from Sanwa Chemical Co., Ltd.).

The melamine crosslinking agent may be used in an amount (content in the top coat layer coating composition) not critical, but preferably from 5 to 100 parts by weight, more preferably from 10 to 80 parts by weight, and furthermore preferably from 20 to 50 parts by weight, per 100 parts by weight of the acrylic polymer in the top coat layer. The melamine crosslinking agent, if used in an amount of less than 5 parts by weight, may fail to sufficiently contribute to satisfactory scratch resistance. In contrast, the melamine crosslinking agent, if used in an amount of more than 100 parts by weight, may cause insufficient printability. The melamine crosslinking agent in this case may also suffer from insufficient compatibility to cause poor visual quality and/or insufficient solvent resistance in some combinations with other components constituting the top coat layer.

The top coat layer, when employing the melamine crosslinking agent in combination with the acrylic polymer derived from substantially no acidic-functional-group-containing monomer, may readily have higher hardness and better adhesion to the base layer, as described above.

The top coat layer preferably contains a lubricant (slip additive) for allowing the pressure-sensitive adhesive sheet according to the present invention to exhibit further better scratch resistance. The lubricant can be any of known or customary lubricants, of which fluorochemical lubricants and silicone lubricants are preferably employed. Among them, silicone lubricants (silicone-based lubricants) are preferred. The silicone lubricants are exemplified by polydimethylsiloxanes, polyether-modified polydimethylsiloxanes, and polymethylalkylsiloxanes. The lubricant for use herein is also exemplified by lubricants containing a fluorochemical compound or silicone compound having an aryl group and/or an aralkyl group. These are also called “printability-imparting lubricants” because they particularly improve the printability. The lubricant is further exemplified by lubricants (reactive lubricants) containing a fluorochemical compound or silicone compound having at least one crosslinkable reactive group.

The lubricant may be used in an amount not critical, but preferably from 5 to 90 parts by weight, more preferably from 10 to 70 parts by weight, furthermore preferably 15 parts by weight or more (e.g., from 15 to 50 parts by weight), particularly preferably 20 parts by weight or more, and most preferably 25 parts by weight or more, per 100 parts by weight of the acrylic polymer in the top coat layer. The lubricant, if used in an amount of less than 5 parts by weight, may fail to contribute to satisfactory scratch resistance. In contrast, the lubricant, if used in an amount of more than 90 parts by weight, may cause insufficient printability or cause the top coat layer (consequently, the transparent film substrate and the pressure-sensitive adhesive sheet) to have insufficient visual quality.

The lubricant reduces the frictional coefficient probably by bleeding out to the top coat layer surface and imparting the lubricity to the surface. Suitable use of the lubricant therefore contributes to better scratch resistance through reduction in frictional coefficient. The lubricant can uniformize the surface tension of the top coat layer coating composition and can contribute to better uniformity in thickness of the top coat layer and to reduction in interference fringes (consequently to better visual quality). Such better visual quality is significant particularly in a surface-protecting film for an optical member. In an embodiment, the acrylic resin constituting the top coat layer is an ultraviolet-curable acrylic resin. In this embodiment, a fluorochemical or silicone lubricant is preferably added to the top coat layer coating composition. When the composition is applied to the base layer and dried, the lubricant bleeds out at the coating surface (interface with the atmosphere), and this suppresses curing inhibition by oxygen during ultraviolet irradiation and allows the ultraviolet-curable acrylic resin to be sufficiently cured even in an outermost surface of the top coat layer.

The top coat layer may further contain one or more additives according to necessity, within ranges not adversely affecting the advantageous effects of the present invention. The additives are exemplified by antistatic components other than polythiophenes, antioxidants, colorants (e.g., pigments and dyestuffs), viscosity-adjusting agents (e.g., thixotropic agents and thickeners), film-forming aids, and catalysts (e.g., ultraviolet-induced polymerization initiators for use in compositions including an ultraviolet-curable acrylic resin).

The antistatic components other than polythiophenes can be any of known or customary antistatic components and are exemplified by, but not limited to, organic or inorganic electroconductive materials and various antistatic agents.

The organic electroconductive materials are exemplified by, but not limited to, electroconductive polymers other than polythiophenes, such as polyanilines, polypyrroles, polyethyleneimines, and allylamine polymers. Each of different electroconductive polymers may be used alone or in combination. Each of the organic electroconductive materials may be used in combination with any of other antistatic components such as inorganic electroconductive materials and antistatic agents.

The polyanilines are also available as commercial products typically under the trade name of “aqua-PASS” (from Mitsubishi Rayon Co., Ltd., an aqueous poly(anilinesulfonic acid) solution).

The inorganic electroconductive materials are exemplified by, but not limited to, tin oxide, antimony oxide, indium oxide, cadmium oxide, titanium oxide, zinc oxide, indium, tin, antimony, gold, silver, copper, aluminum, nickel, chromium, titanium, iron, cobalt, copper iodide, ITO (indium oxide/tin oxide), and ATO (antimony oxide/tin oxide).

The top coat layer in the transparent film substrate of the pressure-sensitive adhesive sheet according to the present invention may be formed by any process without limitation, such as a process of preparing a liquid composition (top coat layer coating composition) by dispersing or dissolving the components such as the acrylic resin, polythiophene, melamine crosslinking agent, and optional additives in a suitable solvent (medium); and applying the liquid composition to the base layer surface. More specifically, preferably employed is a process of applying the liquid composition to the base layer surface, drying the applied composition, and, where necessary, performing a curing treatment (e.g., a heat treatment or ultraviolet irradiation) to form the top coat layer.

The liquid composition (top coat layer coating composition) may have a solids content (NV; non-volatile content) not critical, but preferably 5 percent by weight or less (e.g., from 0.05 to 5 percent by weight), more preferably 1 percent by weight or less (e.g., from 0.1 to 1 percent by weight), furthermore preferably 0.5 percent by weight or less, and particularly preferably 0.3 percent by weight or less. The liquid composition, if having a solids content of more than 5 percent by weight, may have an excessively high viscosity and often suffer from unevenness in drying time from one region to another, and these may impede the formation of a top coat layer that is thin and uniform (namely, with a small thickness variation ΔD). A lower limit of the solids content of the liquid composition is not critical, but is preferably 0.05 percent by weight, and more preferably 0.1 percent by weight. The liquid composition, if having a solids content of less than 0.05 percent by weight, may give a coat (top coat layer) readily suffering from crawling and thereby having a larger thickness variation ΔD in some materials and surface quality of the base layer.

The solvent constituting the liquid composition (top coat layer coating composition) is preferably one capable of stably dissolving or dispersing the components, such as the acrylic resin, polythiophene, and melamine crosslinking agent, to form the top coat layer. The solvent is exemplified by an organic solvent, water, and a mixture of them. The organic solvent is exemplified by esters such as ethyl acetate; ketones such as methyl ethyl ketone, acetone, and cyclohexanone; cyclic ethers such as tetrahydrofuran (THF) and dioxane; aromatic hydrocarbons such as toluene and xylenes; aliphatic or alicyclic alcohols such as methanol, ethanol, n-propanol, isopropyl alcohol, and cyclohexanol; and glycol ethers. Each of different solvents may be used alone or in combination. Among them, preferred for the formation of a stable coat is a solvent containing a glycol ether as a principal component (e.g., a solvent containing 50 percent by weight or more of a glycol ether).

Of the glycol ethers, preferably employed is at least one selected from the group consisting of alkylene glycol monoalkyl ethers and dialkylene glycol monoalkyl ethers. Specifically, they are exemplified by ethylene glycol monomethyl ether, ethylene glycol monoethyl ether, ethylene glycol monopropyl ether, ethylene glycol monobutyl ether, propylene glycol monomethyl ether, propylene glycol monopropyl ether, diethylene glycol monomethyl ether, diethylene glycol monoethyl ether, diethylene glycol monopropyl ether, diethylene glycol monobutyl ether, and diethylene glycol-mono-2-ethylhexyl ether.

The top coat layer has an average thickness Dₐᵥₑ of from 2 to 50 nm, preferably from 2 to 30 nm, more preferably from 2 to 20 nm, and furthermore preferably from 2 to 10 nm. The top coat layer, if having an average thickness Dₐᵥₑ of more than 50 nm, may cause the transparent film substrate to appear cloudy as a whole and may readily cause the transparent film substrate (consequently the pressure-sensitive adhesive sheet having the transparent film substrate) to have inferior visual quality. In contrast, the top coat layer, if having an average thickness Dₐᵥₑ of less than 2 nm, may be difficult to be formed uniformly.

The average thickness Dₐᵥₑ of the top coat layer can be determined by measuring thicknesses of the top coat layer at five different measurement points arranged at regular intervals along a straight line crossing the top coat layer (typically, a straight line crossing the top coat layer in the width direction); and averaging the thickness values at the five measurement points. Of the measurement points, two adjacent measurement points are desirably at a distance of 2 cm or longer (preferably 5 cm or longer) from each other.

The thickness of the top coat layer (thickness of the top coat layer at each measurement point) can be measured typically by observing a cross section of the transparent film substrate (or the pressure-sensitive adhesive sheet) with a transmission electron microscope (TEM). Specifically, the measurement may be performed typically by preparing a sample from the transparent film substrate (or the pressure-sensitive adhesive sheet), staining the sample with a heavy metal to make the top coat layer distinguishable, embedding the stained sample in a resin, slicing the embedded sample ultrathin to give a cross section, and observing the cross section with the TEM. The obtained data can be utilized as the thickness of the top coat layer. Typically, a transmission electron microscope Model “H-7650” supplied by Hitachi, Ltd. can be used as the TEM.

In Examples described later, the thickness (average thickness within the field of view) of the top coat layer was actually measured by obtaining a cross-sectional image at an accelerating voltage of 100 kV and a 60000-fold magnification, converting the image to a binary code, and dividing the cross-sectional area of the top coat layer by the sample length in the field of view.

The heavy-metal staining may be omitted when the top coat layer is sufficiently distinguishable even in observation without any heavy-metal staining.

Alternatively, the thickness of the top coat layer may be determined by calculation using a calibration curve plotted based on correlations between the thickness determined by TEM and values obtained by various other thickness measuring devices (e.g., surface profile gauges, interferometric thickness gauges, infrared spectrometers, and various X-ray diffractometers).

The top coat layer has a thickness variation ΔD of 40% or less (e.g., from 0% to 40%), preferably 30% or less, more preferably 25% or less, and furthermore preferably 20% or less.

The thickness variation ΔD of the top coat layer is determined by measuring thicknesses of the top coat layer at five different measurement points arranged at regular intervals along a straight line crossing the top coat layer (typically, a straight line crossing the top coat layer in the width direction); dividing the difference between the maximum value Dₘₐₓ and the minimum value Dₘᵢₙ of the measured thicknesses by the average thickness Dₐᵥₑ; and defining the resulting value as the thickness variation [i.e., ΔD (%)=(Dₘₐₓ−Dₘᵢₙ)/Dₐᵥₑ×100]. Of the measurement points, two adjacent measurement points are desirably at a distance of 2 cm or longer (preferably 5 cm or longer) from each other. The thickness of the top coat layer at each measurement point can for example be directly measured by TEM observation or can be determined by determining a value with a suitable thickness gauge and converting the value to a thickness based on the calibration curve, as described above.

More specifically, the average thickness Dₐᵥₑ and the thickness variation ΔD of the top coat layer can be determined in accordance with the thickness measurement method outlined in Examples.

The top coat layer, as having a thickness variation ΔD of 40% or less, less appears streaky or uneven due to partial clouding and bring good visual quality. Specifically, with a decreasing thickness variation ΔD can bring better visual quality. The top coat layer, when having a small thickness variation ΔD, also advantageously contributes to the formation of a transparent film substrate having a small average thickness Dₐᵥₑ and a low surface resistivity.

The top coat layer may have an X-ray intensity variation ΔI not critical, but preferably 40% or less (e.g., from 0% to 40%), more preferably 30% or less, furthermore preferably 25% or less, and particularly preferably 20% or less, as determined by X-ray fluorescence (XRF) analysis. The X-ray intensity variation ΔI may be determined by measuring X-ray intensities I through XRF analysis at five different measurement points arranged at regular intervals along a straight line crossing the top coat layer (typically, a straight line crossing the top coat layer in the width direction); dividing the difference between the maximum value Iₘₐₓ and the minimum value Iₘᵢₙ by the average X-ray intensity Iₐᵥₑ; and defining the resulting value as the X-ray intensity variation ΔI [i.e., ΔI (%)=(Iₘₐₓ−Iₘᵢₙ)/Iₐᵥₑ×100]. Of the measurement points, two adjacent measurement points are desirably at a distance of 2 cm or longer (preferably 5 cm or longer) from each other.

The “average X-ray intensity Iₐᵥₑ” herein refers to an arithmetic mean of the X-ray intensities I at the five measurement points. The X-ray intensity is generally indicated in kcps (number (kilo counts) per second of X-ray photons entering through a receiving slit). Specifically, the average intensity Iₐᵥₑ and the X-ray intensity variation ΔI can be measured typically in accordance with the X-ray intensity variation measurement method outlined in Examples. The top coat layer, when having an X-ray intensity variation ΔI of 40% or less, may less appear streaky or uneven due to partial clouding and readily bring good visual quality. In general, the X-ray intensity variation ΔI decreases with a decreasing thickness variation ΔD. The top coat layer, when having a small intensity variation ΔI, may therefore advantageously contribute to the formation of a transparent film substrate having a small average thickness Dₐᵥₑ and a low surface resistivity.

An element to be analyzed by the XRF analysis can be any of XRF-analyzable elements contained in the top coat layer. Of such atoms, preferably employed for the XRF analysis are sulfur atom (e.g., sulfur atom (S) derived from a polythiophene contained in the top coat layer), silicon atom (e.g., silicon atom (Si) derived from a silicone lubricant contained in the top coat layer), and tin atom (e.g., tin atom (Sn) derived from tin oxide particles contained in the top coat layer). In a preferred embodiment, the top coat layer has an X-ray intensity variation ΔI of 40% or less as determined by sulfur atom XRF analysis. In another preferred embodiment, the top coat layer has an X-ray intensity variation ΔI of 40% or less as determined by silicon atom XRF analysis.

The XRF analysis can be performed typically in the following manner. Specifically, a commercially available XRF analyzer is preferably employed. Any of suitable dispersive crystal can be selected, of which a Ge crystal is typically preferably employed. The output settings and other conditions can be suitably selected in accordance with the used instrument. Usually, a sufficient resolution can be obtained with an output of about 70 mA at 50 kV. More specifically, the XRF analysis conditions outlined in Examples can be preferably employed.

In a preferred embodiment for higher measurement accuracy, an element preferred to be analyzed has an X-ray intensity per area corresponding to a 30 mm diameter circle of about 0.01 kcps or more (more preferably 0.03 kcps or more, typically from 0.05 to 3.00 kcps) under predetermined XRF analysis conditions.

The transparent film substrate in the pressure-sensitive adhesive sheet according to the present invention is a transparent substrate including the base layer and, on at least a first face thereof, the top coat layer. Specifically, the transparent film substrate may have a total luminous transmittance in the visible light region not critical, but preferably from 80% to 97% and more preferably from 85% to 95% as determined according to JIS K7361-1. The transparent film substrate may have a haze not critical, but preferably from 1.0% to 5.0% and more preferably from 2.0% to 3.5% as determined according to JIS K7136. The transparent film substrate, if having a total luminous transmittance and/or a haze out of the above-specified range, may often impede the adherend visual inspection.

The transparent film substrate may have a thickness not critical, but preferably from 10 to 150 μm and more preferably from 30 to 100 μm. The transparent film substrate, if having a thickness of less than 10 μm, may fail to effectively protect the optical member from scratches. In contrast, the transparent film substrate, if having a thickness of more than 150 μm, may invite higher cost.

Acrylic Pressure-sensitive Adhesive Layer

The acrylic pressure-sensitive adhesive layer in the pressure-sensitive adhesive sheet according to the present invention is formed from a specific water-dispersible acrylic pressure-sensitive adhesive composition (a water-dispersible removable acrylic pressure-sensitive adhesive composition) (hereinafter also referred to as a “pressure-sensitive adhesive composition for use in the present invention”). The water-dispersible acrylic pressure-sensitive adhesive composition contains an acrylic emulsion polymer (A), a compound (B) represented by Formula (I), and an acetylenic diol compound (C) having a HLB value of less than 13 as essential components, where Formula (I) is expressed as follows:

R^{a}O—(PO)ₗ-(EO)—(PO)ₙ—R^{b} (I)

wherein each of R^{a} and R^{b} independently represents a straight or branched chain alkyl group or hydrogen atom; PO represents oxypropylene group; EO represents oxyethylene group; and each of l, m, and n independently denotes a positive integer, where EO(s) and POs are added in a block manner. In a preferred embodiment, the pressure-sensitive adhesive composition for use in the present invention further contains a water-insoluble crosslinking agent (D). The “compound (B) represented by Formula (I)” is also simply referred to as a “compound (B).”

Acrylic Emulsion Polymer (A)

The acrylic emulsion polymer (A) in the pressure-sensitive adhesive composition for use in the present invention is a polymer (an acrylic polymer) derived from a (meth)acrylic alkyl ester and a carboxyl-containing unsaturated monomer as essential constitutive monomers (constitutive monomer components). Specifically, the acrylic emulsion polymer (A) is a polymer obtained from a monomer mixture containing a (meth)acrylic alkyl ester and a carboxyl-containing unsaturated monomer as essential components. Each of different acrylic emulsion polymers may be used alone or in combination as the acrylic emulsion polymer (A). As used herein the term “(meth)acrylic” refers to “acrylic” and/or “methacrylic” (either one or both of “acrylic” and “methacrylic”).

The (meth)acrylic alkyl ester is used as a principal monomer component to constitute the acrylic emulsion polymer (A) and has the function mainly of exhibiting basic properties as a pressure-sensitive adhesive (or as a pressure-sensitive adhesive layer), such as adhesiveness and removability. Of such (meth)acrylic alkyl esters, acrylic alkyl esters impart flexibility to a polymer constituting the pressure-sensitive adhesive layer and readily help the pressure-sensitive adhesive layer to exhibit adhesion and tackiness; whereas methacrylic alkyl esters impart hardness (rigidity) to the polymer constituting the pressure-sensitive adhesive layer and readily help the pressure-sensitive adhesive layer to have controlled removability. The (meth)acrylic alkyl ester is exemplified by, but not limited to, (meth)acrylic alkyl esters having a straight, branched chain, or cyclic alkyl moiety with 1 to 16 (more preferably 2 to 10, and furthermore preferably 4 to 8) carbon atoms.

Of such acrylic alkyl esters, preferred are acrylic alkyl esters having an alkyl moiety with 2 to 14 (more preferably 4 to 8) carbon atoms, which are exemplified by acrylic alkyl esters having a straight or branched chain alkyl moiety, such as n-butyl acrylate, isobutyl acrylate, s-butyl acrylate, isoamyl acrylate, hexyl acrylate, heptyl acrylate, octyl acrylate, 2-ethylhexyl acrylate, isooctyl acrylate, nonyl acrylate, and isononyl acrylate. Among them, preferred are 2-ethylhexyl acrylate and n-butyl acrylate.

Of methacrylic alkyl esters, preferred are methacrylic alkyl esters having an alkyl moiety with 2 to 16 (more preferably 2 to 8) carbon atoms. These are exemplified by methacrylic alkyl esters having a straight or branched chain alkyl moiety, such as ethyl methacrylate, propyl methacrylate, isopropyl methacrylate, n-butyl methacrylate, isobutyl methacrylate, s-butyl methacrylate, and t-butyl methacrylate; and alicyclic methacrylic alkyl esters such as cyclohexyl methacrylate, bornyl methacrylate, and isobornyl methacrylate. Among them, preferred is n-butyl methacrylate.

For better appearance of the acrylic pressure-sensitive adhesive layer, methyl methacrylate and/or isobornyl acrylate may also be used.

The (meth)acrylic alkyl ester can be suitably selected according typically to the target adhesiveness, and each of different (meth)acrylic alkyl esters may be used alone or in combination.

The (meth)acrylic alkyl ester or esters may be present in a content of from 70 to 99.5 percent by weight, more preferably from 85 to 99 percent by weight, and furthermore preferably from 91 to 98 percent by weight, based on the total weight (100 percent by weight) of constitutive monomers (entire constitutive monomers) constituting the acrylic emulsion polymer (A). The (meth)acrylic alkyl ester, if present in a content of more than 99.5 percent by weight, causes an excessively low content of the carboxyl-containing unsaturated monomer, thereby causes the pressure-sensitive adhesive composition to give a pressure-sensitive adhesive layer having anchoring capability and less-staining properties at insufficient levels or having inferior emulsion stability. In contrast, the (meth)acrylic alkyl ester, if present in a content of less than 70 percent by weight, may fail to effectively contribute to adhesiveness and removability at satisfactory levels. Though not critical, the weight ratio of acrylic alkyl ester(s) to methacrylic alkyl ester(s) in content in the (meth)acrylic alkyl ester(s) is preferably from 100:0 to 30:70 and more preferably from 100:0 to 50:50.

The carboxyl-containing unsaturated monomer can form a protective layer on the surface of emulsion particles formed from the acrylic emulsion polymer (A) and exhibit the function of preventing shear fracture of the emulsion particles. This function is further improved by neutralizing carboxyl group with a base. The stability of emulsion particles against shear fracture is more generally referred to as “mechanical stability”. The carboxyl-containing unsaturated monomer, when used in combination with at least one multifunctional compound reactive with carboxyl group (e.g., a multifunctional epoxy compound), can also act as crosslinking points during the formation of the pressure-sensitive adhesive layer through water removal. In addition, the carboxyl-containing unsaturated monomer may increase the adhesion (anchoring capability) of the pressure-sensitive adhesive layer (acrylic pressure-sensitive adhesive layer) to the substrate (transparent film substrate) through the multifunctional compound. The carboxyl-containing unsaturated monomer is exemplified by (meth)acrylic acid (acrylic acid and methacrylic acid), itaconic acid, maleic acid, fumaric acid, crotonic acid, carboxyethyl acrylate, and carboxypentyl acrylate. The term “carboxyl-containing unsaturated monomer(s)” also refers to and includes acid-anhydride-containing unsaturated monomers such as maleic anhydride and itaconic anhydride. Among them, acrylic acid is preferred for a high relative concentration in the emulsion particle surface and for easy formation of a denser protective layer. Each of different carboxyl-containing unsaturated monomers may be used alone or in combination.

The carboxyl-containing unsaturated monomer or monomers are present in a content of from 0.5 to 10 percent by weight, preferably from 1 to 5 percent by weight, and more preferably from 2 to 4 percent by weight, based on the total weight (100 percent by weight) of constitutive monomers (entire constitutive monomers) constituting the acrylic emulsion polymer (A). The carboxyl-containing unsaturated monomer or monomers, if present in a content of more than 10 percent by weight, may be polymerized in water and invite thickening (viscosity increase), because such a carboxyl-containing unsaturated monomer (e.g., acrylic acid) is generally soluble in water. In addition, a pressure-sensitive adhesive layer, if formed from a composition in this case, may suffer from increase in interaction with the functional group on the adherend polarizing plate surface and thereby suffer from adhesive strength increase with time, and this may impede the removal of the pressure-sensitive adhesive sheet from the adherend. In contrast, the carboxyl-containing unsaturated monomer, if present in a content of less than 0.5 percent by weight, fails to contribute to satisfactory mechanical stability of emulsion particles. The carboxyl-containing unsaturated monomer in this case also invites insufficient adhesion (anchoring capability) of the acrylic pressure-sensitive adhesive layer to the transparent film substrate, thus causing adhesive residue.

For imparting a specific function to the polymer, one or more other monomer components than the (meth)acrylic alkyl esters and the carboxyl-containing unsaturated monomers may be used as monomer components (constitutive monomers) to constitute the acrylic emulsion polymer (A). Examples of the other monomer components are as follows. Typically, for higher cohesive force, there may be added (used) any of amido-containing monomers such as (meth)acrylamide, N,N-diethyl(meth)acrylamide, and N-isopropyl(meth)acrylamide; and amino-containing monomers such as N,N-dimethylaminoethyl (meth)acrylate and N,N-dimethylaminopropyl (meth)acrylate. These may be added in an amount per each category of from about 0.1 to about 15 percent by weight. For refractive index control or for satisfactory reworkability, there may be added (used) any of (meth)acrylic aryl esters such as phenyl (meth)acrylate; vinyl esters such as vinyl acetate and vinyl propionate; and styrenic monomers such as styrene. These may be added in an amount per each category of 15 percent by weight or less. For better crosslinking in the emulsion particles and higher cohesive force, there may be added (used) any of epoxy-containing monomers such as glycidyl (meth)acrylate and allyl glycidyl ether; and multifunctional monomers such as trimethylolpropane tri(meth)acrylate and divinylbenzene. These may be used in an amount per each category of less than 5 percent by weight. For forming hydrazide crosslinks in a combination use with a hydrazide crosslinking agent and thereby particularly improving less-staining properties, there may be added (used) any of keto-containing unsaturated monomers such as diacetoneacrylaide (DAAM), allyl acetoacetate, and 2-(acetoacetoxy)ethyl (meth)acrylate in an amount of less than 10 percent by weight and preferably from 0.5 to 5 percent by weight.

Examples of the other monomer components to be used herein further include hydroxyl-containing unsaturated monomers such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl)methyl acrylate, N-methylol(meth)acrylamide, vinyl alcohol, allyl alcohol, 2-hydroxyethyl vinyl ether, 4-hydroxybutyl vinyl ether, and diethylene glycol monovinyl ether. For further reducing clouding as stain, the amount of the hydroxyl-containing unsaturated monomer to be added (used) is preferably minimal. Specifically, the amount of the hydroxyl-containing unsaturated monomer is preferably less than 1 percent by weight, more preferably less than 0.1 percent by weight, and furthermore preferably substantially zero (e.g., less than 0.05 percent by weight). However, such a hydroxyl-containing unsaturated monomer may be added (used) in an amount of from about 0.01 to about 10 percent by weight when used to introduce crosslinking points typically of crosslinking between hydroxyl group and isocyanate group, or metal crosslinking.

The amount of the other monomer component(s) to be added (used) refers to a content based on the total weight (100 percent by weight) of constitutive monomers (entire constitutive monomers) constituting the acrylic emulsion polymer (A).

In a preferred embodiment particularly for better appearance of the pressure-sensitive adhesive sheet according to the present invention, monomer components (constitutive monomers) constituting the acrylic emulsion polymer (A) include at least one monomer selected from the group consisting of methyl methacrylate, isobornyl acrylate, N,N-diethylacrylamide, and vinyl acetate, of which methyl methacrylate is more preferred. The monomer (the at least one monomer selected from the group consisting of methyl methacrylate, isobornyl acrylate, N,N-diethylacrylamide, and vinyl acetate) may be present in a content of preferably from 0.5 to 15 percent by weight, more preferably from 1 to 10 percent by weight, and furthermore preferably from 2 to 5 percent by weight, based on the total weight (100 percent by weight) of constitutive monomers (entire constitutive monomers) constituting the acrylic emulsion polymer (A). The monomer, if present in a content of less than 0.5 percent by weight, may fail to effectively contribute to better appearance; and, if present in a content of more than 15 percent by weight, may cause the polymer constituting the pressure-sensitive adhesive layer to be excessively rigid, and this may invite insufficient adhesion. When the constitutive monomers constituting the acrylic emulsion polymer (A) include two or more monomers selected from the group consisting of methyl methacrylate, isobornyl acrylate, N,N-diethylacrylamide, and vinyl acetate, the total sum of contents (total content) of methyl methacrylate, isobornyl acrylate, N,N-diethylacrylamide, and vinyl acetate may fall within the above-specified range.

The acrylic emulsion polymer (A) for use herein may be obtained by subjecting the constitutive monomers (monomer mixture) to emulsion polymerization with an emulsifier and a polymerization initiator. In addition, a chain-transfer agent may be used to control the molecular weight of the acrylic emulsion polymer (A).

The emulsifier for use in the emulsion polymerization to form the acrylic emulsion polymer (A) is a reactive emulsifier containing at least one radically polymerizable functional group introduced into the molecule (reactive emulsifier containing a radically polymerizable functional group). Specifically, the acrylic emulsion polymer (A) is an acrylic emulsion polymer polymerized with a reactive emulsifier containing a radically polymerizable functional group in molecule. Each of different reactive emulsifiers containing a radically polymerizable reactive group may be used alone or in combination.

The reactive emulsifier containing a radically polymerizable functional group is hereinafter also simply referred to as “reactive emulsifier.” The reactive emulsifier is an emulsifier containing at least one radically polymerizable functional group in molecule (per molecule). The reactive emulsifier to be used herein can be one or more of various reactive emulsifiers having a radically polymerizable functional group. The radically polymerizable functional group is exemplified by vinyl group, propenyl group, isopropenyl group, vinyl ether group (vinyloxy group), and allyl ether group (allyloxy group). The reactive emulsifier, when used, is integrated into the polymer, and this reduces stains derived from the emulsifier.

The reactive emulsifier is exemplified by reactive emulsifiers having (or corresponding to) a structure of a nonionic-anionic emulsifier, except with a radically polymerizable functional group (radically reactive group), such as propenyl group or allyl ether group being introduced. The “nonionic-anionic emulsifier” refers to an anionic emulsifier having a nonionic hydrophilic group. The nonionic-anionic emulsifier is exemplified by sodium polyoxyethylene alkyl ether sulfates, ammonium polyoxyethylene alkyl phenyl ether sulfates, sodium polyoxyethylene alkyl phenyl ether sulfates, and sodium polyoxyethylene alkyl sulfosuccinates. Hereinafter a reactive emulsifier having a structure corresponding to an anionic emulsifier, except with a radically polymerizable functional group being introduced is referred to as an “anionic reactive emulsifier”; whereas a reactive emulsifier having a structure corresponding to a nonionic-anionic emulsifier, except with a radically polymerizable functional group being introduced is referred to as a “nonionic-anionic reactive emulsifier.”

Of reactive emulsifiers, anionic reactive emulsifiers are preferred, of which nonionic-anionic reactive emulsifiers are more preferred. This is because the anionic reactive emulsifiers are integrated into the polymer to further less cause stains. Particularly when an epoxy-containing multifunctional epoxy crosslinking agent is used as the water-insoluble crosslinking agent (D), the anionic reactive emulsifiers, as having catalytic activity, can help the crosslinking agent to exhibit higher reactivity. If no anionic reactive emulsifier is used, the crosslinking reaction may not complete even through aging. This may cause the pressure-sensitive adhesive layer to have an adhesive strength varying with time and to suffer from increase in adhesive strength to the adherend with time due to the presence of unreacted carboxyl groups. The anionic reactive emulsifiers are also preferred because they are integrated into the polymer, thereby do not precipitate to the adherend surface, and cannot cause clouding as stain, unlike quaternary ammonium compounds (see for example JP-A No. 2007-31585), which are generally used as catalysts for epoxy crosslinking agents.

The reactive emulsifiers are also available as commercial products typically under the trade name of “ADEKA REASOAP SE-10N” (ADEKA CORPORATION), under the trade name of “ADEKA REASOAP SE-20N” (ADEKA CORPORATION), under the trade name of “ADEKA REASOAP SR-10” (ADEKA CORPORATION), under the trade name of “ADEKA REASOAP SR-20” (ADEKA CORPORATION), under the trade name of “AQUALON HS-10” (Dai-ichi Kogyo Seiyaku Co., Ltd.), under the trade name of “AQUALON HS-05” (Dai-ichi Kogyo Seiyaku Co., Ltd.), and under the trade name of “LATEMUL PD-104” (Kao Corporation).

The reactive emulsifier for use herein is preferably one having a SO₄²⁻ ion concentration of 100 μg/g or less, from which impurity ions have been removed. This is because such impurity ions may become a problem. The anionic reactive emulsifier, when used, is preferably an ammonium salt reactive emulsifier. Impurities can be removed from the reactive emulsifier by a suitable process such as a process using an ion-exchange resin, a membrane separation process, or an impurities precipitation-filtration process with an alcohol.

The reactive emulsifier may be blended (used) in an amount of preferably from 0.1 to 10 parts by weight, more preferably from 0.5 to 6 parts by weight, furthermore preferably from 1 to 4.5 parts by weight, and most preferably from 1 to 3 parts by weight, per 100 parts by weight of the total amount of constitutive monomers (entire constitutive monomers) constituting the acrylic emulsion polymer (A). The reactive emulsifier, if blended in an amount of more than 10 parts by weight, may cause the pressure-sensitive adhesive (pressure-sensitive adhesive layer) to have insufficient cohesive force to thereby stain the adherend in a larger quantity, or the emulsifier itself may stain the adherend. In contrast, the reactive emulsifier, if blended in an amount of less than 0.1 part by weight, may fail to maintain stable emulsification.

The polymerization initiator for use in the emulsion polymerization to form the acrylic emulsion polymer (A) is exemplified by, but not limited to, azo polymerization initiators such as 2,2′-azobisisobutyronitrile, 2,2′-azobis(2-amidinopropane) dihydrochloride, 2,2′-azobis[2-(5-methyl-2-imidazolin-2-yl)propane]dihydrochloride, 2,2′-azobis(2-methylpropionamidine) disulfate, and 2,2′-azobis(N,N′-dimethyleneisobutyramidine); persulfates such as potassium peroxodisulfate and ammonium persulfate; peroxide polymerization initiators such as benzoyl peroxide, t-butyl hydroperoxide, and hydrogen peroxide; and redox initiators using a peroxide in combination with a reducing agent, such as redox polymerization initiators using a peroxide and ascorbic acid (e.g., hydrogen peroxide water in combination with ascorbic acid), those using a peroxide in combination with an iron(II) salt (e.g., hydrogen peroxide water in combination with an iron(II) salt), and those using a persulfate in combination with sodium hydrogen-sulfite. Each of different polymerization initiators may be used alone or in combination.

The polymerization initiator may be blended (used) in an amount not critical, but preferably from 0.01 to 1 part by weight and more preferably from 0.02 to 0.5 part by weight, per 100 parts by weight of the total amount of constitutive monomers (entire constitutive monomers) constituting the acrylic emulsion polymer (A), though the amount can be suitably determined according typically to the types of the initiator and the constitutive monomers.

The polymerization to form the acrylic emulsion polymer (A) may employ a chain-transfer agent so as to control the molecular weight of the acrylic emulsion polymer (A). The chain-transfer agent can be any of known or customary chain-transfer agents without limitation and is exemplified by lauryl mercaptan, glycidyl mercaptan, mercaptoacetic acid, 2-mercaptoethanol, thioglycolic acid, 2-ethylhexyl thioglycolate, and 2,3-dimercapto-1-propanol. Each of different chain-transfer agents may be used alone or in combination. The chain-transfer agent is preferably blended (used) in an amount of from 0.001 to 0.5 part by weight, per 100 parts by weight of the total amount of constitutive monomers (entire constitutive monomers) constituting the acrylic emulsion polymer (A).

The emulsion polymerization to form the acrylic emulsion polymer (A) can be performed according to any arbitrary procedure such as regular batch polymerization, continuous dropping polymerization, or portion-wise dropping polymerization. For less staining, the polymerization is desirably performed by batch polymerization at a low temperature (e.g., 55° C. or lower and preferably 30° C. or lower). These conditions are preferred for less staining, probably because the polymerization, when performed under these conditions, readily gives a high-molecular-weight component but gives a smaller amount of a low-molecular-weight component.

The acrylic emulsion polymer (A) is a polymer including constitutional units derived from the (meth)acrylic alkyl ester and constitutional units derived from the carboxyl-containing unsaturated monomer as essential constitutional units. The acrylic emulsion polymer (A) contains the constitutional units derived from the (meth)acrylic alkyl ester in a content of preferably from 70 to 99.5 percent by weight, more preferably from 85 to 99 percent by weight, and furthermore preferably from 91 to 98 percent by weight. The acrylic emulsion polymer (A) contains the constitutional units derived from the carboxyl-containing unsaturated monomer in a content of preferably from 0.5 to 10 percent by weight, more preferably from 1 to 5 percent by weight, and furthermore preferably from 2 to 4 percent by weight.

The acrylic emulsion polymer (A) has a solvent-insoluble content of preferably 70% (percent by weight) or more, more preferably 75 percent by weight or more, and furthermore preferably 80 percent by weight or more. The solvent-insoluble content is a percentage of solvent-insoluble components and is also referred to as a “gel fraction.” The acrylic emulsion polymer (A), if having a solvent-insoluble content of less than 70 percent by weight, may contain large amounts of low-molecular-weight components, and this may impede sufficient reduction of low-molecular-weight components in the pressure-sensitive adhesive layer merely through crosslinking. Thus, the residual low-molecular-weight components may cause the resulting pressure-sensitive adhesive sheet to stain the adherend or to have an excessively high adhesive strength. The solvent-insoluble content can be controlled typically by the polymerization initiator, the reaction temperature, and the types of the emulsifier and constitutive monomers. An upper limit of the solvent-insoluble content is not critical, but is typically 99 percent by weight.

As used herein the “solvent-insoluble content” of the acrylic emulsion polymer (A) refers to a value as calculated by a “solvent-insoluble content measurement method” as follows:

Solvent-insoluble Content Measurement Method

About 0.1 g of the acrylic emulsion polymer (A) is sampled as a specimen, covered with a porous tetrafluoroethylene sheet (trade name “NTF1122” supplied by Nitto Denko Corporation) having an average pore size of 0.2 μm, tied with a kite string, a weight of the resulting article is measured and is defined as a “weight before immersion.” The weight before immersion is a total weight of the acrylic emulsion polymer (A) (the sampled specimen), the tetrafluoroethylene sheet, and the kite string.

Independently, a total weight of the tetrafluoroethylene sheet and the kite string is measured, and the weight is defined as a “tare weight.”

Next, the article including the acrylic emulsion polymer (A) covered with the tetrafluoroethylene sheet and tied with the kite string (this article is hereinafter also referred to as a “sample”) is placed in ethyl acetate filled in a 50-ml vessel and left stand at 23° C. for 7 days. Thereafter the sample (after ethyl acetate treatment) is retrieved from the vessel, transferred into an aluminum cup, dried in an oven at 130° C. for 2 hours to remove ethyl acetate, a weight of the resulting article is measured, and the weight is defined as a “weight after immersion.”

Based on these data, the solvent-insoluble content is calculated according to an equation as follows:

Solvent-insoluble content(percent by weight)=(X−Y)/(Z−Y)×100 (1)

wherein X represents the weight after immersion; Y represents the tare weight; and Z represents the weight before immersion.

The acrylic emulsion polymer (A) may have a weight-average molecular weight (Mw) of a solvent-soluble fraction (hereinafter also referred to as a “sol fraction”) not critical, but preferably from 4×10⁴ to 20×10⁴, more preferably from 5×10′ to 15×10⁴, and furthermore preferably from 6×10⁴ to 10×10⁴. The acrylic emulsion polymer (A), when having a weight-average molecular weight of the solvent-soluble fraction of 4×10⁴ or more, may help the pressure-sensitive adhesive composition to have better wettability with the adherend and thereby contribute to better adhesiveness to the adherend. The acrylic emulsion polymer (A), when having a weight-average molecular weight of the solvent-soluble fraction of 20×10⁴ or less, may help the pressure-sensitive adhesive composition to less remain on the adherend and thereby to further less stain the adherend.

The weight-average molecular weight of the solvent-soluble fraction in the acrylic emulsion polymer (A) can be determined by obtaining an extract (ethyl acetate solution) after the ethyl acetate treatment in the measurement of the solvent-insoluble content of the acrylic emulsion polymer (A); air-drying the extract at room temperature to give a sample (solvent-soluble fraction of the acrylic emulsion polymer (A)); and measuring the weight-average molecular weight of the sample by gel permeation chromatography (GPC). A specific measurement method is exemplified as follows:

Measurement Method

The GPC measurement is performed with a GPC analyzer “HLC-8220GPC” supplied by Tosoh Corporation to determine a molecular weight in terms of a polystyrene standard. Measurement conditions are as follows:

Sample concentration: 0.2 percent by weight (THF solution)

Sample volume: 10 μl

Eluting solvent: THF

Flow rate: 0.6 ml/min

Measurement temperature: 40° C.

Columns: Sample columns; one TSKguardcolumn SuperHZ-H column and two TSKgel SuperHZM-H columns

Reference Column; one TSKgel SuperH-RC column

Detector: differential refractive index detector

The pressure-sensitive adhesive composition for use in the present invention may contain the acrylic emulsion polymer (A) in a content not critical, but preferably 80 percent by weight or more and more preferably from 90 to 99 percent by weight, based on the total weight (100 percent by weight) of non-volatile components contained in the pressure-sensitive adhesive composition.

Compound (B)

The compound (B) in the pressure-sensitive adhesive composition for use in the present invention is a compound represented by Formula (I) expressed as follows:

R^{a}O—(PO)ₗ-(EO)ₘ—(PO)ₙ—R^{b} (I)

As used herein the symbol “PO” represents oxypropylene group [—CH₂CH(CH₃)O—]; and the symbol “EO” represents oxyethylene group [—CH₂CH₂O—].

In Formula (I), each of R^{a} and R^{b} independently represents a straight or branched chain alkyl group or hydrogen atom, where R^{a} and R^{b} may be the same as or different from each other. The straight or branched chain alkyl group is not limited, but is preferably an alkyl group having 1 to 4 carbon atoms, such as methyl group, ethyl group, propyl group, and butyl group. R^{a} and R^{b} are particularly preferably both hydrogen atoms.

In Formula (I), PO represents oxypropylene group [—CH₂CH(CH₃)O—]; each of 1 and n independently denotes a positive integer (an integer of 1 or more) and is preferably an integer of from 1 to 100, more preferably an integer of from 10 to 50, and furthermore preferably an integer of from 10 to 30. The repetition numbers 1 and n may be the same as or different from each other.

In Formula (I), EO represents oxyethylene group [—CH₂CH₂O—]; and m denotes a positive integer (an integer of 1 or more) and is preferably an integer of from 1 to 50, more preferably an integer of from 1 to 30, and furthermore preferably an integer of from 1 to 15.

In Formula (I), EO(s) and POs are added (copolymerized) in a block manner. Specifically, the compound (B) is a triblock copolymer or a derivative thereof, which triblock copolymer has an EO block [a polyoxyethylene block or polyethylene glycol (PEG) block] and PO blocks [polyoxypropylene blocks or polypropylene glycol (PPG) blocks] present on both sides of the EO block.

The compound (B) has a percentage (ratio) of the “total weight of EO(s)” based on the “total weight of the compound(s) (B)” not critical, but preferably 50 percent by weight or less, more preferably from 5 to 50 percent by weight, and furthermore preferably from 10 to 30 percent by weight. The percentage is expressed in weight percent (%) as: [(Total weight of EO(s))/(Total weight of the compound(s) (B))×100]. The compound (B), if having the percentage (EO content) of more than 50 percent by weight, may have higher hydrophilicity and lose defoaming activity. The compound (B), if having the percentage of less than 5 percent by weight, may have excessively high hydrophobicity and thereby cause crawling. The term “total weight of the compound(s) (B)” refers to the “total weight of entire compounds (B) in the pressure-sensitive adhesive composition for use in the present invention”; and the term “total weight of EO(s)” refers to the “total weight of EOs contained in entire compounds (B) in the pressure-sensitive adhesive composition for use in the present invention.” The percentage of the “total weight of EO(s)” based on the “total weight of the compound(s) (B)” is also referred to as “ethylene oxide content” or “EO content.” The EO content may be measured by a method such as nuclear magnetic resonance spectrometry (NMR), chromatography, or time-of-flight secondary ion mass spectrometry (TOF-SIMS).

The compound (B) may have a number-average molecular weight (Mn) not critical, but preferably from 1200 to 4000 and more preferably from 1500 to 3500. The compound (B), if having a number-average molecular weight (Mn) of more than 4000, may cause stains on the adherend; whereas, if having a number-average molecular weight (Mn) of less than 1200, may also cause stains on the adherend. The “number-average molecular weight (Mn)” refers to a number-average molecular weight of entire compounds (B) contained in the pressure-sensitive adhesive composition for use in the present invention. The “number-average molecular weight (Mn)” refers to a value as measured by gel permeation chromatography (GPC). An exemplary specific measurement method is as follows:

Measurement Method

The molecular weight is measured with a GPC analyzer “HLC-8220GPC” supplied by Tosoh Corporation and determined in terms of a polystyrene standard. The measurement is performed under conditions as follows:

Sample concentration: 0.2 percent by weight (THF solution)

Sample volume: 10 μl

Eluting solvent: THF

Flow rate: 0.6 ml/min

Measurement temperature: 40° C.

Columns: Sample columns; one TSKguardcolumn SuperHZ-H column and two TSKgel SuperHZM-H columns

Reference column; one TSKgel SuperH-RC column

Detector: differential refractive index detector

The compound (B) can be obtained typically by reacting a fatty acid or higher alcohol with ethylene oxide and propylene oxide; or by reacting ethylene glycol with propylene glycol.

The compound (B) is also available as any of commercial products typically under the trade names of “ADEKA Pluronic 25R-1”, “ADEKA Pluronic 25R-2”, “ADEKA Pluronic 17R-2”, and “ADEKA Pluronic 17R-3” each from ADEKA CORPORATION; “Pluronic RPE Series” from BASF Japan Ltd.; “Poly(ethylene glycol)-block-poly(propylene glycol)-block-poly(ethylene glycol)” from SIGMA-ALDRICH Co., LLC.

Each of different compounds (B) may be used alone or in combination.

The compound(s) (B) may be blended in an amount (content in the pressure-sensitive adhesive composition for use in the present invention) not critical, but preferably from 0.01 to 2.5 parts by weight, more preferably from 0.01 to 1.5 parts by weight, furthermore preferably from 0.02 to 1.0 part by weight, still more preferably from 0.02 to 0.5 part by weight, and most preferably from 0.02 to 0.3 part by weight, per 100 parts by weight of the acrylic emulsion polymer (A). The compound(s) (B), if blended in an amount of less than 0.01 part by weight, may fail to contribute to sufficient defoaming activity (and may often cause visual defects due to bubble defects); whereas, if blended in an amount of more than 2.5 parts by weight, may readily cause stains on the adherend.

The compound (B), when blended to prepare the pressure-sensitive adhesive composition for use in the present invention, is preferably blended alone without the use of a solvent. However, typically for better blending workability, the compound (B) may be used in the form of a dispersion or solution in a solvent. The solvent is exemplified by 2-ethylhexanol, Butyl CELLOSOLVE, dipropylene glycol, ethylene glycol, propylene glycol, n-propyl alcohol, and isopropyl alcohol.

The compound (B), as blended in the pressure-sensitive adhesive composition, exhibits a defoaming activity to reduce or eliminate bubble-derived defects.

The compound (B) has a block structure, in which the polyoxyethylene block is present in the central part of the molecule, and blocks of PO serving as a hydrophobic group are present at both ends of the molecule. The compound (B) is therefore resistant to uniform alignment at the vapor-liquid interface and excels particularly in defoaming activity. As compared to such PPG-PEG-PPG triblock copolymers, PEG-PPG-PEG triblock copolymers having polyoxyethylene blocks at both ends of the molecule, diblock copolymers of a polyoxyethylene and a polyoxypropylene, and random copolymers of EO and PO are readily uniformly aligned at the vapor-liquid interface and exhibit inferior defoaming activities.

In addition, the compound (B) is highly hydrophobic, thereby less causes clouding as stain on the adherend in a high-humidity environment, and contributes to reduction in staining. In contrast, a highly hydrophilic compound (particularly a water-soluble compound) often causes clouding as stain when placed in a high-humidity environment, because the hydrophilic compound is dissolved in water and readily transfers to (migrates to) the adherend, or bleeds onto the adherend, swells, and readily cause clouding.

The pressure-sensitive adhesive composition for use in the present invention, as employing the compound (B), gives an acrylic pressure-sensitive adhesive layer that is resistant to clouding even during storage under humid conditions (hygroscopic clouding). When the pressure-sensitive adhesive sheet is used as a surface-protecting film for an optical member, clouding of the pressure-sensitive adhesive layer (namely clouding of the pressure-sensitive adhesive sheet), if occurs, may impede or adversely affect the inspection process of the optical member.

Acetylenic Diol Compound (C)

The acetylenic diol compound (C) in the pressure-sensitive adhesive composition for use in the present invention is a diol compound having at least one acetylenic bond per molecule. The acetylenic diol compound (C) is preferably, but not limited to, any of a compound represented by following Formula (II) and a compound represented by following Formula (III).

Specifically, the acetylenic diol compound (C) is typically preferably the compound represented by Formula (II) expressed as follows:

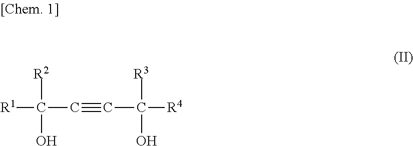

In Formula (II), each of R¹, R², R³, and R⁴ independently represents a hydrocarbon group having 1 to 20 carbon atoms and may contain one or more heteroatoms. R¹, R², R³, and R⁴ may be the same as or different from one another.

Each of R¹, R², R³, and R⁴ in Formula (II) may have a straight or branched chain structure. Among these substituents, each of R¹ and R⁴ is independently preferably an alkyl group having 2 to 10 carbon atoms and is more preferably one having 4 carbon atoms, i.e., n-butyl group, sec-butyl group, tert-butyl group, or isobutyl group; and each of R² and R³ is independently preferably an alkyl group having 1 to 4 carbon atoms and is more preferably one having 1 or 2 carbon atoms, i.e., methyl group or ethyl group.

The acetylenic diol compound (C) represented by Formula (II) is specifically exemplified by 7,10-dimethyl-8-hexadecyne-7,10-diol, 4,7-dimethyl-5-decyne-4,7-diol, 2,4,7,9-tetramethyl-5-decyne-4,7-diol, and 3,6-dimethyl-4-octyne-3,6-diol.

For better blending workability, the acetylenic diol compound (C) represented by Formula (II), when to be blended to prepare the pressure-sensitive adhesive composition for use in the present invention, may be used in the form of a dispersion or solution in a solvent. The solvent is exemplified by 2-ethylhexanol, Butyl CELLOSOLVE, dipropylene glycol, ethylene glycol, propylene glycol, n-propyl alcohol, and isopropyl alcohol. Of these solvents, preferably employed is ethylene glycol and/or propylene glycol for satisfactory dispersibility in the emulsion system. When the dispersion or solution of the acetylenic diol compound (C) in the solvent is employed for blending, the solvent content is preferably less than 40 percent by weight (e.g., from 15 to 35 percent by weight) for ethylene glycol as the solvent; and is preferably less than 70 percent by weight (e.g., from 20 to 60 percent by weight) for propylene glycol as the solvent, each based on the total weight (100 percent by weight) of the dispersion or solution.

The acetylenic diol compound (C) represented by Formula (II) is also available as any of commercial products such as Surfynol 104 Series from Air Products and Chemicals Inc., which are more specifically exemplified by Surfynol 104E, Surfynol 104H, Surfynol 104A, Surfynol 104BC, Surfynol 104DPM, Surfynol 104PA, and Surfynol 104PG-50.

The acetylenic diol compound (C) is also preferably a compound represented by Formula (III) expressed as follows:

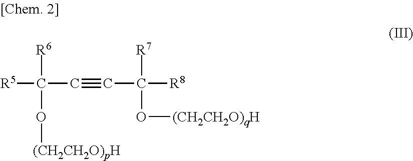

In Formula (III), each of R⁵, R⁶, R⁷, and R⁸ independently represents a hydrocarbon group having 1 to 20 carbon atoms and may contain one or more heteroatoms. R⁵, R⁶, R⁷, and R⁸ may be the same as or different from one another. Each of p and q in Formula (III) independently denotes an integer of 0 or more, where the total [p+q] of p and q is 1 or more, preferably from 1 to 20, and more preferably from 1 to 9. The numbers p and q may be the same as or different from each other. The numbers p and q are regulated so as to allow the acetylenic diol compound (C) to have a HLB value of less than 13. When p is 0, the group [—O—(CH₂CH₂O)ₚH] is hydroxyl group [—OH], and the same is true for the number q.

Each of R⁵, R⁶, R⁷, and R⁸ in Formula (III) may independently have a straight or branched chain structure. Among these substituents, each of R⁵ and R⁸ is independently preferably an alkyl group having 2 to 10 carbon atoms and is more preferably one having 4 carbon atoms, i.e., n-butyl group, sec-butyl group, tert-butyl group, or isobutyl group; whereas each of R⁶ and R⁷ is independently preferably an alkyl group having 1 to 4 carbon atoms and more preferably one having 1 or 2 carbon atoms, i.e., methyl group or ethyl group.

The acetylenic diol compound (C) represented by Formula (III) is specifically exemplified by ethylene oxide adducts of 7,10-dimethyl-8-hexadecyne-7,10-diol; of 4,7-dimethyl-5-decyne-4,7-diol; of 2,4,7,9-tetramethyl-5-decyne-4,7-diol; and of 3,6-dimethyl-4-octyne-3,6-diol. The ethylene oxide adduct of 2,4,7,9-tetramethyl-5-decyne-4,7-diol preferably has an average number of moles of added ethylene oxide moieties of 9 or less.

The numbers p and q in Formula (III) are regulated so as to allow the acetylenic diol compound (C) to have a HLB value of less than 13. Typically when the acetylenic diol compound (C) represented by Formula (III) is the ethylene oxide adduct of 2,4,7,9-tetramethyl-5-decyne-4,7-diol, the total of p and q is preferably 9 or less.

The acetylenic diol compound (C) represented by Formula (III) (ethylene-oxide-added acetylenic diol compound), when blended to prepare the pressure-sensitive adhesive composition for use in the present invention, is preferably blended alone without the use of a solvent. However, for better blending workability, the acetylenic diol compound (C) may be used in the form of a dispersion or solution in a solvent. The solvent is exemplified by 2-ethylhexanol, Butyl CELLOSOLVE, dipropylene glycol, ethylene glycol, propylene glycol, n-propyl alcohol, and isopropyl alcohol. Of these solvents, preferably employed is ethylene glycol and/or propylene glycol for satisfactory dispersibility in the emulsion system.

The acetylenic diol compound (C) represented by Formula (III) is also available as any of commercial products such as Surfynol 400 Series from Air Products and Chemicals Inc., which are more specifically exemplified by Surfynol 420 and Surfynol 440.

Each of different acetylenic diol compounds may be used alone or in combination as the acetylenic diol compound (C).

The acetylenic diol compound (C) has a HLB value of less than 13, preferably from 1 to 10, more preferably from 3 to 8, and furthermore preferably from 3 to 5. The HLB value is also simply referred to as “HLB.” The acetylenic diol compound (C), if having a HLB value of 13 or more, may cause more stains on the adherend. The HLB value is a hydrophile-lipophile balance as defined by Griffin and indicates the degree of affinity of a surfactant for water and for oils. The definition of the HLB values is described typically by W. C. Griffin in J. Soc. Cosmetic Chemists, 1, 311 (1949); and by Koshitami TAKAHASHI, Yoshiro NAMBA, Motoo KOIKE, and Masao KOBAYASHI in “Handbook of Surfactants,” 3rd Ed., Kogaku Tosho K.K., Tokyo Japan, Nov. 25, 1972, pp. 179-182.

The acetylenic diol compound (C) is blended in an amount (content in the pressure-sensitive adhesive composition for use in the present invention) of preferably from 0.01 to 10 parts by weight, more preferably from 0.1 to 7 parts by weight, and furthermore preferably from 0.5 to 5 parts by weight, per 100 parts by weight of the acrylic emulsion polymer (A). The acetylenic diol compound (C), if blended in an amount of less than 0.01 part by weight, may fail to sufficiently suppress visual defects of dimples caused by the water-insoluble crosslinking agent; and, if blended in an amount of more than 10 parts by weight, may stain the adherend.

The acetylenic diol compound (C), as being blended, can suppress dimple defects derived from a water-insoluble crosslinking agent. This is probably because the acetylenic diol compound (C) effectively helps the water-insoluble crosslinking agent to be dispersed more satisfactorily in the pressure-sensitive adhesive composition and exhibits the leveling function upon the formation of the pressure-sensitive adhesive layer.

Water-Insoluble Crosslinking Agent (D)

The pressure-sensitive adhesive composition for use in the present invention preferably further contains a water-insoluble crosslinking agent (D). The water-insoluble crosslinking agent (D) is a water-insoluble compound and has two or more (e.g., two to six) carboxyl-reactive functional groups in molecule (per molecule). The carboxyl-reactive functional groups are capable of reacting with carboxyl group. The water-insoluble crosslinking agent (D) preferably has three to five carboxyl-reactive functional groups per molecule. With an increasing number of carboxyl-reactive functional groups per molecule, the pressure-sensitive adhesive composition undergoes denser crosslinking. Specifically, the polymer constituting the pressure-sensitive adhesive layer has a denser crosslinked structure. This can prevent the spread by wetting of the pressure-sensitive adhesive layer after its formation. In addition, such dense crosslinked structure constrains the polymer constituting the pressure-sensitive adhesive layer and thereby prevents increase in adhesive strength of the pressure-sensitive adhesive layer to the adherend with time. The adhesive strength increase with time is caused by segregation of functional groups (carboxyl groups) contained in the pressure-sensitive adhesive layer to the surface in contact with the adherend. In contrast, the water-insoluble crosslinking agent (D), if having carboxyl-reactive functional groups in an excessively large number of more than 6 per molecule, may cause the formation of a gelled substance.

The carboxyl-reactive functional groups in the water-insoluble crosslinking agent (D) are exemplified by, but not limited to, epoxy groups, isocyanate groups, and carbodiimide groups. Among them, epoxy groups are preferred for satisfactory reactivity. Of epoxy groups, glycidylamino group is more preferred because this group is highly reactive, less causes unreacted components or moieties to remain after the crosslinking reaction, thereby advantageously contributes to reduction in staining, and prevents increase in adhesive strength to the adherend with time, which increase is caused by unreacted carboxyl groups remained in the pressure-sensitive adhesive layer. Specifically, the water-insoluble crosslinking agent (D) is preferably an epoxy crosslinking agent having epoxy groups, and is more preferably a crosslinking agent having glycidylamino groups (glycidylamino crosslinking agent). The water-insoluble crosslinking agent (D), when being an epoxy crosslinking agent (particularly a glycidylamino crosslinking agent), has two or more (e.g., two to six) epoxy groups (particularly glycidylamino groups) per molecule, and preferably has three to five epoxy groups (particularly glycidylamino groups).

The water-insoluble crosslinking agent (D) is a water-insoluble compound. As used herein the term “water-insoluble” refers to that the compound (crosslinking agent) in question has a solubility of 5 parts by weight or less in 100 parts by weight of water at 25° C. The solubility is preferably 3 parts by weight or less and furthermore preferably 2 parts by weight or less. The solubility is the weight of the compound (crosslinking agent) soluble in 100 parts by weight of water. The water-insoluble crosslinking agent, when used and even when remained as uncrosslinked, less causes clouding as stain on the adherend in a high-humidity environment and thus further lesses stains the adherend. When crosslinking is performed with a water-soluble crosslinking agent alone, and the resulting pressure-sensitive adhesive sheet is placed in a high-humidity environment, the crosslinking agent remained after crosslinking is dissolved in water, readily transfers or migrates to the adherend, and often causes clouding as stain. The water-insoluble crosslinking agent contributes to the crosslinking reaction (reaction with carboxyl group) more than, and effectively prevents adhesive strength increase with time more than, the water-soluble crosslinking agent does. In addition, the water-insoluble crosslinking agent has high reactivity for the crosslinking reaction, thereby facilitates the crosslinking reaction through aging, and prevents increase in adhesive strength to the adherend with time, which increase is caused by unreacted carboxyl groups in the pressure-sensitive adhesive layer.

The water solubility of the crosslinking agent can be measured typically by a method as follows:

Water Solubility Measurement Method

Water (25° C.) and the sample crosslinking agent in equal weights are mixed with each other at a number of revolutions of 300 rpm for 10 minutes, and the mixture is centrifugally separated into an aqueous phase and an oily phase. Next, the aqueous phase is collected, dried at 120° C. for one hour, a weight loss on drying is calculated, based on which a content of non-volatile components (non-volatile content) in the aqueous phase is determined. The non-volatile content is indicated in part by weight of non-volatile components per 100 parts by weight of water.

Specific examples of the water-insoluble crosslinking agent (D) include glycidylamino crosslinking agents such as 1,3-bis(N,N-diglycidylaminomethyl)cyclohexane (e.g., trade name “TETRAD-C” supplied by MITSUBISHI GAS CHEMICAL COMPANY, INC.) [solubility in 100 parts by weight of water at 25° C.: 2 parts by weight or less] and 1,3-bis(N,N-diglycidylaminomethyl)benzene (e.g., trade name “TETRAD-X” supplied by MITSUBISHI GAS CHEMICAL COMPANY, INC.) [solubility in 100 parts by weight of water at 25° C.: 2 parts by weight or less]; and other epoxy crosslinking agents such as tris(2,3-epoxypropyl) isocyanurate (e.g., trade name “TEPIC-G” supplied by Nissan Chemical Industries, Ltd.) [solubility in 100 parts by weight of water at 25° C.: 2 parts by weight or less]. Each of different water-insoluble crosslinking agents may be used alone or in combination as the water-insoluble crosslinking agent (D).

The water-insoluble crosslinking agent (D), when blended to prepare the pressure-sensitive adhesive composition for use in the present invention, may be added (blended) as intact when being a liquid water-insoluble crosslinking agent (D), or may be dissolved in and/or diluted with an organic solvent. However, such an organic solvent is preferably used in a minimum amount. It is not desirable to add the water-insoluble crosslinking agent (D) as an emulsion prepared by emulsifying the agent (D) with an emulsifier. This is because the emulsifier bleeds out and readily causes stains (particularly clouding as stain).

The water-insoluble crosslinking agent (D) is preferably blended in such an amount (content in the pressure-sensitive adhesive composition for use in the present invention) that the carboxyl-reactive functional groups of the water-insoluble crosslinking agent (D) be present in an amount of from 0.3 to 1.3 moles per 1 mole of carboxyl groups of the carboxyl-containing unsaturated monomer used as a constitutive monomer constituting the acrylic emulsion polymer (A). Specifically, a molar ratio [(carboxyl-reactive functional group)/(carboxyl group)] is preferably from 0.3 to 1.3, more preferably from 0.4 to 1.1, and furthermore preferably from 0.5 to 1.0, which ratio is of the “total number of moles of carboxyl-reactive functional groups in entire water-insoluble crosslinking agents (D)” to the “total number of moles of carboxyl groups of entire carboxyl-containing unsaturated monomers used as constitutive monomers constituting the acrylic emulsion polymer (A).” If the ratio [(carboxyl-reactive functional group)/(carboxyl group)] is less than 0.3, the pressure-sensitive adhesive layer may contain a large amount of unreacted carboxyl groups, which may interact with the adherend and cause adhesive strength increase with time. If the ratio [(carboxyl-reactive functional group)/(carboxyl group)] is more than 1.3, the pressure-sensitive adhesive layer may contain a large amount of unreacted water-insoluble crosslinking agents (D), and this may cause visual defects.

Particularly when the water-insoluble crosslinking agent (D) is an epoxy crosslinking agent, the molar ratio [(epoxy group)/(carboxyl group)] is preferably from 0.3 to 1.3, more preferably from 0.4 to 1.1, and furthermore preferably from 0.5 to 1.0. When the water-insoluble crosslinking agent (D) is a glycidylamino crosslinking agent, the molar ratio [(glycidylamino group)/(carboxyl group)] preferably falls within the above-specified range.

Typically when 4 g of a water-insoluble crosslinking agent (D) having a carboxyl-reactive functional group equivalent of 110 (g/eq) is added (blended) to the pressure-sensitive adhesive composition, the number of moles of the carboxyl-reactive functional groups in the water-insoluble crosslinking agent (D) can be calculated typically according to an equation as follows:

Number of moles of carboxyl-reactive functional groups of the water-insoluble crosslinking agent(D)=[Amount of the water-insoluble crosslinking agent(D)to be blended(to be added)]/[Functional group equivalent]=4/110

For example, when 4 g of an epoxy crosslinking agent having an epoxy equivalent of 110 (g/eq) is added (blended) as the water-insoluble crosslinking agent (D), the number of moles of epoxy groups in the epoxy crosslinking agent can be calculated typically according to an equation as follows:

Number of moles of epoxy groups of the epoxy crosslinking agent=[Amount of the epoxy crosslinking agent to be blended(to be added)]/[Epoxy equivalent]=4/110

The pressure-sensitive adhesive composition for use in the present invention contains the acrylic emulsion polymer (A), the compound (B), and the acetylenic diol compound (C) as essential components, as described above. The composition preferably further contains the water-insoluble crosslinking agent (D). Where necessary, the pressure-sensitive adhesive composition for use in the present invention may further contain any of crosslinking agents other than water-insoluble crosslinking agents (D) (hereinafter also referred to as “other crosslinking agents”); polyoxyalkylene (polyether) compounds other than compounds (B) (hereinafter also referred to as “other polyoxyalkylene compounds”); and other additives.

The pressure-sensitive adhesive composition for use in the present invention is a water-dispersible pressure-sensitive adhesive composition. As used herein the term “water-dispersible” refers to that the substance in question is dispersible in an aqueous medium. Specifically, the pressure-sensitive adhesive composition for use in the present invention is a pressure-sensitive adhesive composition that is dispersible in an aqueous medium. The aqueous medium refers to a medium (dispersion medium) including water as an essential component and may include water alone or a mixture of water with a water-soluble (water-miscible) organic solvent. The pressure-sensitive adhesive composition for use in the present invention may be a dispersion typically in the aqueous medium.

The pressure-sensitive adhesive composition for use in the present invention may contain one or more crosslinking agents (other crosslinking agents) than the water-insoluble crosslinking agents (D). Preferred examples of other crosslinking agents include, but not limited to, multifunctional hydrazide crosslinking agents. A multifunctional hydrazide crosslinking agent, when used, can help the pressure-sensitive adhesive composition to give a pressure-sensitive adhesive layer that is improved in removability, adhesiveness, and anchoring capability with respect to the substrate. The multifunctional hydrazide crosslinking agent is a compound having at least two hydrazide groups in molecule (per molecule). The multifunctional hydrazide crosslinking agent is hereinafter also simply referred to as “hydrazide crosslinking agent.” The hydrazide crosslinking agent preferably has two or three hydrazide groups and more preferably has two hydrazide groups per molecule. Preferred compounds to be used as the hydrazide crosslinking agent include, but not limited to, dihydrazide compounds such as oxalic dihydrazide, malonic dihydrazide, succinic dihydrazide, glutaric dihydrazide, adipic dihydrazide, pimelic dihydrazide, suberic dihydrazide, azelaic dihydrazide, sebacic dihydrazide, dodecanedioic dihydrazide, phthalic dihydrazide, isophthalic dihydrazide, terephthalic dihydrazide, 2,6-naphthalenedicarboxylic dihydrazide, naphthalic dihydrazide, acetonedicarboxylic dihydrazide, fumaric dihydrazide, maleic dihydrazide, itaconic dihydrazide, trimellitic dihydrazide, 1,3,5-benzenetricarboxylic dihydrazide, pyromellitic dihydrazide, and aconitic dihydrazide. Among them, adipic dihydrazide and sebacic dihydrazide are particularly preferred. Each of different hydrazide crosslinking agents may be used alone or in combination.

The hydrazide crosslinking agent to be used herein is also available as any of commercial products such as “Adipic Dihydrazide (Reagent)” supplied by Tokyo Chemical Industry Co., Ltd.: and “Adipoyl Dihydrazide (Reagent)” supplied by Wako Pure Chemical Industries, Ltd.

The hydrazide crosslinking agent is blended in an amount (content in the pressure-sensitive adhesive composition for use in the present invention) of preferably from 0.025 to 2.5 moles, more preferably from 0.1 to 2 moles, and furthermore preferably from 0.2 to 1.5 moles, per 1 mole of keto groups in a keto-containing unsaturated monomer to be used as a constitutive monomer constituting the acrylic emulsion polymer (A). The hydrazide crosslinking agent, if blended in an amount of less than 0.025 moles, may fail to exhibit sufficient effects of its addition, and this may cause the pressure-sensitive adhesive layer or the pressure-sensitive adhesive sheet to be removed heavily (hardly) and may cause low-molecular-weight components to remain in the polymer constituting the pressure-sensitive adhesive layer, thus readily causing clouding as stain on the adherend. The hydrazide crosslinking agent, if blended in an amount of more than 2.5 moles, may remain as an unreacted crosslinking agent component and thereby cause stains.

For less staining, the pressure-sensitive adhesive composition for use in the present invention is preferably incorporated with no quaternary ammonium salt and is more preferably incorporated with no quaternary ammonium compound. Accordingly, the pressure-sensitive adhesive composition for use in the present invention preferably contains substantially no quaternary ammonium salt and more preferably contains substantially no quaternary ammonium compound. These compounds are generally used typically as catalysts for better reactivity of epoxy crosslinking agents. These compounds, however, are not integrated into the polymer constituting the pressure-sensitive adhesive layer, can freely move or migrate in the pressure-sensitive adhesive layer, and thereby readily precipitate to the surface in contact with the adherend. For these reasons, the compounds, when contained in the pressure-sensitive adhesive composition, may readily cause clouding as stain and impede effective reduction in staining. Specifically, the pressure-sensitive adhesive composition for use in the present invention has a content of quaternary ammonium salts of preferably less than 0.1 percent by weight, more preferably less than 0.01 percent by weight, and furthermore preferably less than 0.005 percent by weight, based on the total weight (100 percent by weight) of non-volatile components in the pressure-sensitive adhesive composition. The pressure-sensitive adhesive composition for use in the present invention more preferably has a content of quaternary ammonium compounds falling within the above-specified range.

The quaternary ammonium salts are exemplified by, but not limited to, compounds represented by a formula expressed as follows:

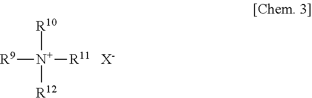

In the formula, each of R⁹, R¹⁰, R¹¹, and R¹² represents not hydrogen atom, but an alkyl group, an aryl group, or a group derived from them (e.g., a substituted alkyl group or aryl group); and X⁻ represents a counter ion.

The quaternary ammonium salts and the quaternary ammonium compounds are exemplified by, but not limited to, alkylammonium hydroxides such as tetramethylammonium (TMAH) hydroxide, tetraethylammonium hydroxide, tetrapropylammonium hydroxide, and tetrabutylammonium hydroxide, and salts of them; arylammonium hydroxides such as tetraphenylammonium hydroxide, and salts of them; and bases and salts of them, which bases include, as a cation, any of trilaurylmethylammonium ion, didecyldimethylammonium ion, dicocoyldimethylammonium ion, distearyldimethylammonium ion, dioleyldimethylammonium ion, cetyltrimethylammonium ion, stearyltrimethylammonium ion, behenyltrimethylammonium ion, cocoylbis(2-hydroxyethyl)methylammonium ion, polyoxyethylene(15) coco-stearylmethylammonium ion, oleylbis(2-hydroxyethyl)methylammonium ion, cocobenzyldimethylammonium ion, laurylbis(2-hydroxyethyl)methylammonium ion, and decylbis(2-hydroxyethyl)methylammonium ion.

In a preferred embodiment for less staining, the pressure-sensitive adhesive composition for use in the present invention is incorporated with none of tertiary amines and imidazole compounds. Such tertiary amines and imidazole compounds are generally used typically as catalysts for improving the reactivity of epoxy crosslinking agents, as with the quaternary ammonium salts (or quaternary ammonium compounds). Accordingly, the pressure-sensitive adhesive composition for use in the present invention preferably contains substantially none of tertiary amines and imidazole compounds. Specifically, the pressure-sensitive adhesive composition for use in the present invention has a content of tertiary amines and imidazole compounds (a total content of tertiary amines and imidazole compounds) of preferably less than 0.1 percent by weight, more preferably less than 0.01 percent by weight, and furthermore preferably less than 0.005 percent by weight, based on the total weight (100 percent by weight) of non-volatile components in the pressure-sensitive adhesive composition.

The tertiary amines are exemplified by tertiary amine compounds such as triethylamine, benzyldimethylamine, and α-methylbenzyl-dimethylamine. The imidazole compounds are exemplified by 2-methylimidazole, 2-heptadecylimidazole, 2-phenylimidazole, 4-ethylimidazole, 4-dodecylimidazole, 2-phenyl-4-hydroxymethylimidazole, 2-ethyl-4-hydroxymethylimidazole, 1-cyanoethyl-4-methylimidazole, and 2-phenyl-4,5-dihydroxymethylimidazole.

In another preferred embodiment, the pressure-sensitive adhesive composition for use in the present invention contains substantially no hydrophobic silica. Specifically, the pressure-sensitive adhesive composition for use in the present invention has a content of hydrophobic silica of preferably less than 5×10⁻⁴ percent by weight, more preferably less than 1×10⁻⁴ percent by weight, furthermore preferably less than 1×10⁻⁵ percent by weight, and most preferably 0 percent by weight, based on the total weight (100 percent by weight) of non-volatile components in the pressure-sensitive adhesive composition. The hydrophobic silica, if contained in the pressure-sensitive adhesive composition, may form secondary aggregates acting as silica particles and may disadvantageously cause defects (visual defects). When the pressure-sensitive adhesive composition containing such silica particles is filtrated typically through a filter, the filter may be clogged with the silica particles, and this may disadvantageously lower the production efficiency.

The pressure-sensitive adhesive composition for use in the present invention may contain any of various additives other than those mentioned above, within ranges not adversely affecting the reduction in staining. The additives are exemplified by pigments, fillers, dispersing agents, plasticizers, stabilizers, antioxidants, ultraviolet absorbers, ultraviolet stabilizers, age inhibitors, and antiseptic agents.

The pressure-sensitive adhesive composition for use in the present invention can be prepared by mixing the acrylic emulsion polymer (A), the compound (B), and the acetylenic diol compound (C). Where necessary, there may be added and mixed any of the water-insoluble crosslinking agent (D) and other crosslinking agents, other polyoxyalkylene compounds, and other additives. The mixing may be performed by any known or customary process of mixing an emulsion, but preferably by stirring with a stirrer. The stirring may be performed under any conditions, but is performed at a temperature of preferably from 10° C. to 50° C. and more preferably from 20° C. to 35° C. for a duration of preferably from 5 to 30 minutes and more preferably from 10 to 20 minutes at a number of revolutions of preferably from 10 to 2000 rpm and more preferably from 30 to 1000 rpm.

The resulting pressure-sensitive adhesive composition for use in the present invention is applied to at least one side of the transparent film substrate and dried according to necessity to form an acrylic pressure-sensitive adhesive layer. This gives a pressure-sensitive adhesive sheet according to the present invention, which is a pressure-sensitive adhesive sheet having a transparent film substrate and, on at least one side thereof, an acrylic pressure-sensitive adhesive layer, in which the acrylic pressure-sensitive adhesive layer is formed from the pressure-sensitive adhesive composition for use in the present invention. Crosslinking may be performed typically by heating the pressure-sensitive adhesive sheet after dehydration and drying in the drying step. The acrylic pressure-sensitive adhesive layer in the pressure-sensitive adhesive sheet according to the present invention is preferably formed by a so-called direct process, in which the pressure-sensitive adhesive composition is applied directly onto the transparent film substrate surface, as described above. The acrylic pressure-sensitive adhesive layer may also be formed by a so-called transfer process, in which an acrylic pressure-sensitive adhesive layer is once provided on a release film, and the formed acrylic pressure-sensitive adhesive layer is transferred (laminated) to the transparent film substrate. However, the acrylic pressure-sensitive adhesive layer, if formed by the transfer process, may fail to have sufficient anchoring capability (adhesion) to the transparent film substrate, because the acrylic pressure-sensitive adhesive layer has a high solvent-insoluble content. For this reason, the direct process is preferably employed. However, the pressure-sensitive adhesive sheet according to the present invention is not limited in its production process, as long as being a pressure-sensitive adhesive sheet having the substrate and, on at least one side thereof, an acrylic pressure-sensitive adhesive layer formed from the pressure-sensitive adhesive composition.

The application of (the coating with) the pressure-sensitive adhesive composition can be performed a known coating procedure and employ a customary coater such as rotogravure roll coater, reverse roll coater, kiss-contact roll coater, dip roll coater, bar coater, knife coater, spray coater, comma coater, or direct coater.

The acrylic pressure-sensitive adhesive layer (after crosslinking) in the pressure-sensitive adhesive sheet according to the present invention may have a thickness not critical, but preferably from 1 to 50 μm, more preferably from 1 to 35 μm, and furthermore preferably from 3 to 25 μm.

The acrylic pressure-sensitive adhesive layer (after crosslinking) may have a solvent-insoluble content not critical, but preferably 90 percent by weight or more and more preferably 95 percent by weight or more. The acrylic pressure-sensitive adhesive layer (after crosslinking), if having a solvent-insoluble content of less than 90 percent by weight, may cause stains (contaminants) to transfer more to the adherend to cause clouding as stain or may cause the pressure-sensitive adhesive sheet to have insufficient removability (to be hardly or heavily removed). Though not critical, an upper limit of the solvent-insoluble content of the acrylic pressure-sensitive adhesive layer (after crosslinking) is typically preferably 99 percent by weight.

The solvent-insoluble content of the acrylic pressure-sensitive adhesive layer (after crosslinking) can be measured by the procedure as with the measurement method of the solvent-insoluble content of the acrylic emulsion polymer (A). Specifically, the solvent-insoluble content can be measured by a procedure corresponding to the “solvent-insoluble content measurement method”, except that the term “acrylic emulsion polymer (A)” is read as “acrylic pressure-sensitive adhesive layer (after crosslinking).”

The acrylic pressure-sensitive adhesive layer (after crosslinking) in the pressure-sensitive adhesive sheet according to the present invention has an elongation at breaking point of preferably 200% or less, more preferably 150% or less, furthermore preferably 130% or less, still more preferably from 40% to 120%, and most preferably from 60% to 115%, as determined by a tensile test. This range is preferred from the viewpoint of the degree of crosslinking of the pressure-sensitive adhesive layer. The elongation at breaking point serves as an index of the degree of crosslinking of the pressure-sensitive adhesive layer. The acrylic pressure-sensitive adhesive layer, when having an elongation at breaking point of 200% or less, may include a polymer having a dense crosslinked structure. This can prevent the spread by wetting of the pressure-sensitive adhesive layer after its formation. Such dense crosslinked structure also constrains the polymer constituting the pressure-sensitive adhesive layer and thereby prevents the acrylic pressure-sensitive adhesive layer from having an increasing adhesive strength to the adherend, in which the increase in adhesive strength is caused by segregation of the functional groups (carboxyl groups) in the pressure-sensitive adhesive layer to the surface in contact with the adherend.

The elongation at breaking point of the acrylic pressure-sensitive adhesive layer (after crosslinking) at 23° C. can be measured by a tensile test. Though not limited, the elongation at breaking point can be determined specifically typically by rounding an acrylic pressure-sensitive adhesive layer (after crosslinking) to give a cylindrical sample having a length of 50 mm and a cross-sectional area (base area) of 1 mm²; subjecting the sample to a tensile test using a tensile tester with an initial length (chuck-to-chuck distance) of 10 mm at a tensile speed of 50 mm/min at an ambient temperature of 23° C. and relative humidity of 50%; and measuring an elongation at breaking point.

More specifically, the acrylic pressure-sensitive adhesive layer (after crosslinking) for use in the tensile test can be prepared typically by a method as follows.

The pressure-sensitive adhesive composition for use in the present invention is applied to a suitable release film to a dry thickness of 50 μm, dried in an oven with internal air circulation at 120° C. for 2 minutes, further aged at 50° C. for 3 days, and yields the acrylic pressure-sensitive adhesive layer. The release film for use herein is exemplified by, but not limited to, a PET film having a surface treated with a silicone. Such release film is also available typically as a commercial product such as “MRF38” from Mitsubishi Plastics, Inc.

The acrylic polymer (after crosslinking) constituting the acrylic pressure-sensitive adhesive layer may have a glass transition temperature not critical, but preferably from −70° C. to −10° C., more preferably from −70° C. to −20° C., furthermore preferably from −70° C. to −40° C., and most preferably from −70° C. to −60° C. The acrylic polymer, if having a glass transition temperature of higher than −10° C., may cause the acrylic pressure-sensitive adhesive layer to have an insufficient adhesive strength and to suffer from gaps or separation typically upon working. In contrast, the acrylic polymer, if having a glass transition temperature of lower than −70° C., may cause the acrylic pressure-sensitive adhesive layer to be less removable when peeled off at a higher peel rate (at a higher tensile speed), thus inviting insufficient working efficiency. The glass transition temperature of the acrylic polymer (after crosslinking) constituting the acrylic pressure-sensitive adhesive layer can be adjusted typically by the monomer composition (monomer formulation) to prepare the acrylic emulsion polymer (A).

The pressure-sensitive adhesive sheet according to the present invention has an adhesive strength to a polarizing plate (triacetyl cellulose (TAC) plate) of preferably from 0.01 to 5 N/25 mm, more preferably from 0.02 to 3 N/25 mm, furthermore preferably from 0.03 to 2 N/25 mm, and most preferably from 0.04 to 1 N/25 mm. The polarizing plate for use herein is one having an arithmetic mean surface roughness Ra of 50 nm or less. The adhesive strength is measured by a 180-degree peel test at a tensile speed of 0.3 m/min and determined as a release force when the pressure-sensitive adhesive sheet once applied to the polarizing plate is peeled off therefrom. The pressure-sensitive adhesive sheet, if having the adhesive strength of more than 5 N/25 mm, may become heavily removable in the production process of a polarizing plate or liquid crystal display device and cause inferior productivity and handleability. The pressure-sensitive adhesive sheet, if having the adhesive strength of less than 0.01 N/25 mm, may suffer from gaps or separation in the production process and exhibit an insufficient protection function as a surface-protecting pressure-sensitive adhesive sheet. The arithmetic mean surface roughness Ra can be measured typically with the KLA-Tencor P-15 (stylus surface profilometer). Though conditions are not limited, the surface roughness (arithmetic mean surface roughness Ra) can be measured typically at a measurement length of 1000 μm, a scanning speed of 50 μm/sec, and a scanning pass count of one pass with a load of 2 mg.

The pressure-sensitive adhesive sheet according to the present invention may have a total luminous transmittance in the visible light region not critical, but preferably from 80% to 97% and more preferably from 85% to 95% as determined according to JIS K7361-1. The pressure-sensitive adhesive sheet according to the present invention may have a haze not critical, but preferably from 1.0% to 3.5% and more preferably from 2.0% to 3.2%, as determined according to JIS K7136. The pressure-sensitive adhesive sheet, if having a total luminous transmittance and/or a haze out of the above-specified range, may often impede the visual inspection of the adherend with the pressure-sensitive adhesive sheet.

The top coat layer surface of the transparent film substrate, namely, the top coat layer surface of the pressure-sensitive adhesive sheet according to the present invention, may have a surface resistivity not critical, but preferably 100×10⁸Ω/square or less (e.g., from 0.1×10⁸ to 100×10⁸Ω/square), more preferably 50×10⁸Ω/square or less (e.g., from 0.1×10⁸ to 50×10⁸Ω/square), and furthermore preferably from 1×10⁸ to 50×10⁸Ω/square. The pressure-sensitive adhesive sheet, when having a surface resistivity of 100×10⁸Ω/square or less on the top coat layer surface, is preferably usable particularly as a surface-protecting film typically in the working or transportation process of static-sensitive articles such as liquid crystal cells and semiconductor devices. The surface resistivity value can be calculated from a surface resistance, which is measured with a commercially available insulation resistance measurement instrument at an ambient temperature of 23° C. and relative humidity of 55%. Specifically, preferably employed is a surface resistivity value obtained by the surface resistivity measurement method outlined in Examples.

The top coat layer surface of the transparent film substrate, namely, the top coat layer surface of the pressure-sensitive adhesive sheet according to the present invention, may have a frictional coefficient not critical, but preferably 0.4 or less. The pressure-sensitive adhesive sheet, when controlled to have a small frictional coefficient of 0.4 or less and when receives a load (such a load as to cause scratches) on the top coat layer surface, can turn the load aside along the top coat layer surface and thus contribute to a lower frictional force. This further satisfactorily prevents an event where the top coat layer undergoes cohesive failure or is separated from the base layer (suffers from interfacial failure) to cause scratches. A lower limit of the frictional coefficient is not critical, but is typically preferably 0.1 and more preferably 0.15 in consideration of balance with other properties such as visual quality and printability. Specifically, the top coat layer may have a frictional coefficient not critical, but preferably from 0.1 to 0.4 and more preferably from 0.15 to 0.4.

The frictional coefficient can for example be a value determined by rubbing the top coat layer surface of the transparent film substrate (or of the pressure-sensitive adhesive sheet according to the present invention) with a vertical load of 40 mN and measuring a frictional coefficient at an ambient temperature of 23° C. and relative humidity of 50%. The frictional coefficient can be reduced (controlled) by a suitable technique such as a technique of incorporating a lubricant of every kind (e.g., a leveling agent) to the top coat layer; or a technique of increasing the crosslinking density of the top coat layer by adding a crosslinking agent or adjusting the film-forming conditions.

In a preferred embodiment, the top coat layer surface of the transparent film substrate, namely, the top coat layer surface of the pressure-sensitive adhesive sheet according to the present invention, has such a property as to be easily printable with an oil-based ink or a water-based ink (e.g., with an oil-based marker). This property is hereinafter also referred to as “printability.” When the surface-protecting film (pressure-sensitive adhesive sheet) according to this embodiment is applied onto an adherend (e.g., an optical component) and when the adherend with the surface-protecting film is in a working or transportation process, the surface-protecting film is suitable for printing and indicating, for example, an identification number of the adherend to be protected. The pressure-sensitive adhesive sheet according to the preferred embodiment of the present invention therefore serves as a surface-protecting film having not only superior visual quality but also excellent printability. In a more preferred embodiment, the pressure-sensitive adhesive sheet serves as a surface-protecting film having satisfactory printability with an oil-based ink containing a pigment in an alcoholic solvent. In another preferred embodiment, the pressure-sensitive adhesive sheet has such a property as to be resistant to rub-off of printed ink by friction or transferring. This property is also referred to as “ink adhesion.” The level of printability can be grasped typically by a printability evaluation as follows:

Printability (Ink Adhesion) Evaluation

The top coat layer surface is printed with Xstamper supplied by Shachihata Inc.; on top of the print, is affixed a cellophane pressure-sensitive adhesive tape (product No. 405, 19 mm wide) supplied by Nichiban Co., Ltd.; and the tape is peeled off at a peel speed of 30 m/min and a peel angle of 180 degrees. The post-peeling surface is visually observed. This measurement is performed at an ambient temperature of 23° C. and relative humidity of 50%. A sample having a peeled area of the print of 50% or larger is evaluated as poor (poor printability); whereas a sample having an unpeeled area of the print of 50% or larger is evaluated as good (good printability).

In another preferred embodiment, the top coat layer surface of the transparent film substrate, namely, the top coat layer surface of the pressure-sensitive adhesive sheet according to the present invention, has solvent resistance at such a level where rubbing off the ink with an alcohol (e.g., ethanol) for modification or deletion would not cause significant changes (cloudiness) to the appearance. The solvent resistance level can be assessed typically by a solvent resistance evaluation as follows.

Solvent Resistance Evaluation

In a dark room blocked from outside light, the top coat layer surface is wiped 15 times with a cleaning cloth (fabric) wetted with ethanol, and the appearance of the wiped surface is visually observed. A sample indicating no visual change between regions wiped with ethanol and the other regions (indicating no visual change due to wiping with ethanol) is evaluated as good (good solvent resistance); whereas a sample indicating wiping streaks is evaluated as poor (poor solvent resistance).

The pressure-sensitive adhesive sheet according to the present invention satisfactorily less causes clouding as stain on the adherend. This can be evaluated typically in a manner as follows. The pressure-sensitive adhesive sheet is laminated onto a polarizing plate (trade name “SEG1425DUHC” supplied by Nitto Denko Corporation) at 0.25 MPa and 0.3 m/min, left stand at 80° C. for 4 hours, and the pressure-sensitive adhesive sheet is removed from the polarizing plate. The polarizing plate, from which the pressure-sensitive adhesive sheet has been removed, is further left stand at an ambient temperature of 23° C. and relative humidity of 90% for 12 hours, and the surface of the resulting polarizing plate is observed. It is preferred that no clouding is observed in the polarizing plate surface. A pressure-sensitive adhesive sheet, if causing clouding on the adherend polarizing plate under humidified conditions (high-humidity conditions) after the application and removal thereof, may insufficiently less stain the adherend when used as a surface-protecting film for an optical member.

The pressure-sensitive adhesive sheet according to the present invention can be in the form of a roll and can be wound into a roll with a release film (separator) protecting the acrylic pressure-sensitive adhesive layer. The backside of the pressure-sensitive adhesive sheet may bear a back treatment layer (a surface release treatment layer or a soil-resistant layer) as formed by a surface release treatment and/or a soil resistant finishing. These treatments are performed typically with any of releasing agents such as silicone, fluorochemical, long-chain alkyl, or fatty amide releasing agents; and silica powders. The “backside” refers to a surface of the pressure-sensitive adhesive sheet opposite to the surface bearing the acrylic pressure-sensitive adhesive layer and is generally the top coat layer surface. In a preferred embodiment, the pressure-sensitive adhesive sheet according to the present invention has a structure of [(acrylic pressure-sensitive adhesive layer)/(transparent film substrate)/(back treatment layer)].

The pressure-sensitive adhesive sheet according to the present invention has adhesiveness and removability (easiness to remove) at satisfactory levels, can be removed, and is usable in applications where the sheet will be removed (for removing uses). Specifically, the pressure-sensitive adhesive sheet according to the present invention is preferably used in applications where the sheet will be removed. Such applications are exemplified by masking tapes such as those for protection or curing in construction, those for automobile painting, those for electronic components (e.g., lead frames and printed circuit boards), and those for sand blasting; surface-protecting films such as those for aluminum sash, those for optical plastics, those for optical glass, those for automobiles, and those for metal plates; pressure-sensitive adhesive tapes for use in production processes of semiconductor/electronic components, such as backgrinding tapes, pellicle-fixing tapes, dicing tapes, lead-frame-fixing tapes, cleaning tapes, dedusting tapes, carrier tapes, and cover tapes; packaging tapes for electronic appliances and electronic components; temporal tacking tapes upon transportation; binding tapes; and labels.

In addition, the pressure-sensitive adhesive sheet according to the present invention less suffers from “dimples” and other visual defects in the pressure-sensitive adhesive layer, less appears cloudy even though having a top coat layer, and has superior visual quality. The pressure-sensitive adhesive sheet, when applied to an adherend, causes less or no stains, such as clouding as stain, on the adherend and satisfactorily reduces staining. In addition, the pressure-sensitive adhesive sheet according to the present invention, as having the top coat layer, has scratch resistance and antistatic properties at satisfactory levels. For these reasons, the pressure-sensitive adhesive sheet according to the present invention is preferably usable for the surface protection of optical members (e.g., optical plastics, optical glass, and optical films) typically as a surface-protecting film for an optical member. The optical members are exemplified by polarizing plates, retardation films, anti-reflective films, wave plates, compensation films, and brightness enhancing films constituting panels such as liquid crystal displays, organic electroluminescence (organic EL) displays, and field emission displays. This is because particularly excellent properties, such as visual quality, less-staining properties, scratch resistance, and antistatic properties, are required in these applications. However, the pressure-sensitive adhesive sheet can also be used for other applications not limited to the above ones and can be used typically in surface-protection, failure-prevention, removal of foreign matter, or masking upon production of microfabricated components such as semiconductors (semiconductor devices), circuits, printed circuit boards, masks, and lead frames.

### EXAMPLES

The present invention will be illustrated in further detail with reference to several examples as follows, which are by no means intended to limit the scope of the invention.

### Production Example 1

### Production Example of Transparent Film Substrate

Preparation of Top Coat Layer Coating Composition

In a reactor was placed 25 g of toluene, the reactor inside temperature was raised to 105° C., and a solution was continuously added dropwise to toluene in the reactor over 2 hours. The solution was a mixture of 30 g of methyl methacrylate (MMA), 10 g of n-butyl acrylate (BA), 5 g of cyclohexyl methacrylate (CHMA), and 0.2 g of azobisisobutyronitrile. After the completion of dropwise addition, the reactor inside temperature was adjusted to a temperature range of from 110° C. to 115° C., and a copolymerization reaction was performed by holding the resulting mixture within the temperature range for 3 hours. After a lapse of 3 hours, the mixture in the reactor was combined with a mixture of 4 g of toluene and 0.1 g of azobisisobutyronitrile added dropwise and then held within the temperature range for one hour. The reactor inside temperature was allowed to fall down to 90° C., and the mixture was diluted with toluene so as to have a NV of 5 percent by weight, and yielded a solution (Binder Solution 1) containing 5 percent by weight of an acrylic polymer as a binder (Binder Polymer 1; Tg: 48° C.) in toluene.

Next, 2 g of Binder Solution 1 (containing 0.1 g of Binder Polymer 1) and 40 g of ethylene glycol monoethyl ether were placed in a 150-mL beaker, followed by stirring. The mixture in the beaker was further combined with 1.2 g of Electroconductive Polymer Solution 1 (aqueous solution) containing a polyethylenedioxythiophene (PEDT) and a polystyrenesulfonate (PSS) and having a NV of 4.0 percent by weight, 55 g of ethylene glycol monomethyl ether, 0.05 g of a polyether-modified polydimethylsiloxane leveling agent (lubricant solution) (trade name “BYK-300” supplied by BYK Chemie GmbH, NV: 52 percent by weight), and 0.02 g of a melamine crosslinking agent (trade name “NIKALAC MW-30M” supplied by Sanwa Chemical Co., Ltd., non-volatile content: 100%), followed by vigorous stirring for about 20 minutes. In this manner, was prepared a top coat layer coating composition (NV: 0.2 percent by weight). This contained 48 parts by weight of the electroconductive polymer, 26 parts by weight of the lubricant, and 20 parts by weight of the melamine crosslinking agent per 100 parts by weight of Binder Polymer 1 (acrylic polymer) each in solids content.

Top Coat Layer Formation

To a 38 μm thick by 30 cm wide by 40 cm long transparent poly(ethylene terephthalate) film (PET film) having one surface treated with corona discharge, the top coat layer coating composition was applied on the corona-discharged surface using a bar coater to a dry thickness of about 10 nm. The applied composition was dried by heating at 130° C. for 2 minutes to form a top coat layer on one side of the PET film. In this manner, was prepared a transparent film substrate (hereinafter also referred to as Substrate 1, i.e, “SUB 1”) having a PET film and, on one side thereof, a transparent top coat layer.

### Production Example 2

### Production Example of Transparent Film Substrate

A transparent film substrate (hereinafter also referred to as “SUB 2”) having a PET film and, on one side thereof, a transparent top coat layer was prepared by the procedure of Production Example 1, except for using Electroconductive Polymer Solution 1 in an amount of 2.5 g instead of 1.2 g; using ethylene glycol monomethyl ether in an amount of 17 g instead of 55 g; and applying the resulting top coat layer coating solution to a dry thickness of about 20 nm.

### Production Example 3

### Production Example of Transparent Film Substrate

A transparent film substrate (hereinafter also referred to as “SUB 3”) having a PET film and, on one side thereof, a transparent top coat layer was prepared by the procedure of Production Example 1, except for using ethylene glycol monoethyl ether in an amount of 19 g instead of 40 g; using Electroconductive Polymer Solution 1 in an amount of 0.7 g instead of 1.2 g; using no ethylene glycol monomethyl ether; and applying the resulting top coat layer coating solution to a dry thickness of about 40 nm.

### Production Example 4

### Production Example of Transparent Film Substrate

A transparent film substrate (hereinafter also referred to as “SUB 4”) having a PET film and, on one side thereof, a transparent top coat layer was prepared by the procedure of Production Example 3, except for using ethylene glycol monoethyl ether in an amount of 15 g instead of 19 g; and applying the resulting top coat layer coating solution to a dry thickness of about 50 nm.

### Production Example 5

### Production Example of Transparent Film Substrate

Preparation of Top Coat Layer Coating Composition

In a reactor was placed 25 g of toluene, the reactor inside temperature was raised to 105° C., and a solution was continuously added dropwise to toluene in the reactor over 2 hours. The solution was a mixture of 32 g of methyl methacrylate (MMA), 5 g of n-butyl acrylate (BA), 0.7 g of methacrylic acid (MAA), 5 g of cyclohexyl methacrylate (CHMA), and 0.2 g of azobisisobutyronitrile. After the completion of dropwise addition, the reactor inside temperature was adjusted to a temperature range of from 110° C. to 115° C., and a copolymerization reaction was performed by holding the resulting mixture within the temperature range for 3 hours. After a lapse of 3 hours, the mixture in the reactor was combined with a mixture of 4 g of toluene and 0.1 g of azobisisobutyronitrile added dropwise and then held within the temperature range for one hour. The reactor inside temperature was allowed to fall down to 90° C., and the mixture was diluted with 31 g of toluene. In this manner, was prepared a solution (Binder Solution 2) containing about 42 percent by weight of an acrylic polymer as a binder (Binder Polymer 2; Tg: 72° C.) in toluene.

Next, 5.5 g of Binder Solution 2 (containing 2.3 g of Binder Polymer 2) and 30 g of ethylene glycol monoethyl ether were placed in a 150-mL beaker, followed by stirring. The mixture in the beaker was further combined with 14 g of Electroconductive Polymer Solution 2 (aqueous solution) containing PEDT and PSS and having a NV of 1.3 percent by weight, 6 g of ethylene glycol monomethyl ether, and 0.5 g of the lubricant solution (BYK-300), followed by vigorous stirring for about 30 minutes. In this manner, was prepared a top coat layer coating composition containing 8 parts by weight of the electroconductive polymer and 11 parts by weight of the lubricant per 100 parts by weight of Binder Polymer 2 (acrylic polymer) each in solids content. This top coat layer coating composition was incorporated with no crosslinking agent.

Top Coat Layer Formation

To a 38 μm thick by 30 cm wide by 40 cm long transparent poly(ethylene terephthalate) film (PET film) having one surface treated with corona discharge, the top coat layer coating composition was applied on the corona-discharged surface using a bar coater to a dry thickness of about 610 nm. The applied composition was dried by heating at 80° C. for 2 minutes to form a top coat layer. In this manner, was prepared a transparent film substrate (hereinafter also referred to as “SUB 5”) having a PET film and, on one side thereof, a transparent top coat layer.

### Production Example 6

### Production Example of Transparent Film Substrate

Preparation of Top Coat Layer Coating Composition

In a reactor was placed 25 g of toluene, the reactor inside temperature was raised to 105° C., and a solution was continuously added dropwise to toluene in the reactor over 2 hours. The solution was a mixture of 30 g of methyl methacrylate (MMA), 10 g of n-butyl acrylate (BA), 5 g of cyclohexyl methacrylate (CHMA), 5 g of hydroxyethyl methacrylate (HEMA), and 0.2 g of azobisisobutyronitrile. After the completion of dropwise addition, the reactor inside temperature was adjusted to a temperature range of from 110° C. to 115° C., and a copolymerization reaction was performed by holding the resulting mixture within the temperature range for 3 hours. After a lapse of 3 hours, the mixture in the reactor was combined with a mixture of 4 g of toluene and 0.1 g of azobisisobutyronitrile added dropwise and then held within the temperature range for one hour. The reactor inside temperature was allowed to fall down to 90° C., and the mixture was diluted with toluene. In this manner, was prepared a solution (Binder Solution 3) containing about 5 percent by weight of an acrylic polymer as a binder (Binder Polymer 3; Tg: 49° C.) in toluene.

Next, 2 g of Binder Solution 3 (containing 0.1 g of Binder Polymer 3) and 40 g of ethylene glycol monoethyl ether were placed in a 150-mL beaker, followed by stirring. The mixture in the beaker was further combined with 1.2 g of Electroconductive Polymer Solution 1 (aqueous solution) containing a polyethylenedioxythiophene (PEDT) and a polystyrenesulfonate (PSS) and having a NV of 4.0 percent by weight, 55 g of ethylene glycol monomethyl ether, 0.05 g of a polyether-modified polydimethylsiloxane leveling agent (lubricant solution) (trade name “BYK-300” supplied by BYK Chemie GmbH, NV: 52 percent by weight), and 0.02 g of a melamine crosslinking agent (trade name “NIKALAC MW-30M” supplied by Sanwa Chemical Co., Ltd.), followed by vigorous stirring for about 20 minutes. In this manner, was prepared a top coat layer coating composition (NV: 0.2 percent by weight). This contained 48 parts by weight of the electroconductive polymer, 26 parts by weight of the lubricant, and 20 parts by weight of the melamine crosslinking agent per 100 parts by weight of Binder Polymer 3 (acrylic polymer) each in solids content.

Top Coat Layer Formation

To a 38 μm thick by 30 cm wide by 40 cm long transparent poly(ethylene terephthalate) film (PET film) having one surface treated with corona discharge, the top coat layer coating composition was applied on the corona-discharged surface using a bar coater to a dry thickness of about 8 nm. The applied composition was dried by heating at 130° C. for 2 minutes to form a top coat layer on one side of the PET film. In this manner, was prepared a transparent film substrate (hereinafter also referred to as “SUB 6”) having a PET film and, on one side thereof, a transparent top coat layer.

Table 1 indicates the top coat layer formulations in the above-prepared transparent film substrates (SUBs 1 to 6), and evaluation data of these transparent film substrates according to evaluation procedures mentioned later.

### Production Example 7

### Production Example of Water-dispersible Acrylic Pressure-sensitive Adhesive Composition

Acrylic Emulsion Polymer Preparation

In a vessel were placed 90 parts by weight of water, and, as indicated in Table 2, 96 parts by weight of 2-ethylhexyl acrylate (2EHA), 4 parts by weight of acrylic acid (AA), and 3 parts by weight of a nonionic-anionic reactive emulsifier (trade name “AQUALON HS-10” supplied by Dai-ichi Kogyo Seiyaku Co., Ltd.), the mixture was stirred by a homomixer, and yielded a monomer emulsion.

Next, 50 parts by weight of water, 0.01 part by weight of a polymerization initiator (ammonium persulfate), and the above-prepared monomer emulsion in an amount corresponding to 10 percent by weight of the prepared amount were placed in a reactor equipped with a condenser, a nitrogen inlet tube, a thermometer, and a stirrer; and the mixture was subjected to emulsion polymerization at 75° C. for one hour with stirring. The mixture was further combined with 0.05 part by weight of the polymerization initiator (ammonium persulfate), subsequently further combined with the whole quantity of the residual monomer emulsion (in an amount corresponding to 90 percent by weight) added over 3 hours with stirring, and allowed to react at 75° C. for 3 hours. Next, this was cooled down to 30° C., combined with an aqueous ammonia having a concentration of 10 percent by weight so as to have a pH of 8, and yielded an acrylic emulsion polymer water dispersion.

Preparation of Water-dispersible Acrylic Pressure-sensitive Adhesive Composition

The above-obtained acrylic emulsion polymer water dispersion was combined with 3 parts by weight of an epoxy crosslinking agent [trade name “TETRAD-C” supplied by MITSUBISHI GAS CHEMICAL COMPANY, INC., 1,3-bis(N,N-diglycidylaminomethyl)cyclohexane, epoxy equivalent: 110, number of functional groups: 4] serving as a water-insoluble crosslinking agent, 1.0 part by weight of “ADEKA Pluronic 25R-1” as a compound (B), and 1.0 part by weight (0.75 parts by weight in terms of acetylenic diol compound) of an acetylenic diol compound (composition) having a HLB value of 4 [trade name “Surfynol 104H” supplied by Air Products and Chemicals Inc., active ingredient: 75 percent by weight] as an acetylenic diol compound (C), per 100 parts by weight of solid components in the acrylic emulsion polymer, and the mixture was stirred at 23° C. and 300 rpm for 10 minutes, and yielded a water-dispersible acrylic pressure-sensitive adhesive composition (hereinafter also referred to as “PSA 1” (pressure-sensitive adhesive 1)).

### Production Example 8

### Production Example of Water-dispersible Acrylic Pressure-sensitive Adhesive Composition

A water-dispersible acrylic pressure-sensitive adhesive composition (hereinafter also referred to as “PSA 2”) was prepared by the procedure of Production Example 7, except for using, as an acetylenic diol compound (C) instead of “Surfynol 104H”, 1.0 part by weight of an acetylenic diol compound (composition) having a HLB value of 4 [trade name “Surfynol 104PG-50” supplied by Air Products and Chemicals Inc., active ingredient: 50 percent by weight](the amount corresponding to 0.5 part by weight in terms of the acetylenic diol compound), as indicated in Table 2.

### Production Example 9

### Production Example of Water-Dispersible Acrylic Pressure-Sensitive Adhesive Composition

A water-dispersible acrylic pressure-sensitive adhesive composition (hereinafter also referred to as “PSA 3”) was prepared by the procedure of Production Example 7, except for using, as an acetylenic diol compound (C) instead of “Surfynol 104H”, 1.0 part by weight of an acetylenic diol compound (composition) having a HLB value of 4 [trade name “Surfynol 420” supplied by Air Products and Chemicals Inc., active ingredient: 100 percent by weight](the amount corresponding to 1.0 part by weight in terms of the acetylenic diol compound), as indicated in Table 2.

### Production Example 10

### Production Example of Water-dispersible Acrylic Pressure-sensitive Adhesive Composition

A water-dispersible acrylic pressure-sensitive adhesive composition (hereinafter also referred to as “PSA 4”) was prepared by the procedure of Production Example 7, except for using, as an acetylenic diol compound (C) instead of “Surfynol 104H”, 1.0 part by weight of an acetylenic diol compound (composition) having a HLB value of 8 [trade name “Surfynol 440” supplied by Air Products and Chemicals Inc., active ingredient: 100 percent by weight](the amount corresponding to 1.0 part by weight in terms of the acetylenic diol compound), as indicated in Table 2.

### Production Example 11

### Production Example of Water-dispersible Acrylic Pressure-sensitive Adhesive Composition

A water-dispersible acrylic pressure-sensitive adhesive composition (hereinafter also referred to as “PSA 5”) was prepared by the procedure of Production Example 7, except for using, as an emulsifier instead of “AQUALON HS-10”, 3 parts by weight of “ADEKA REASOAP SE-10N” as indicated in Table 2.

### Production Example 12

### Production Example of Water-Dispersible Acrylic Pressure-Sensitive Adhesive Composition

A water-dispersible acrylic pressure-sensitive adhesive composition (hereinafter also referred to as “PSA 6”) was prepared by the procedure of Production Example 7, except for using 92 parts by weight of 2-ethylhexyl acrylate (2EHA), 4 parts by weight of methyl methacrylate (MMA), and 4 parts by weight of acrylic acid (AA) as constitutive monomers to form an acrylic emulsion polymer, as indicated in Table 2.

### Production Example 13

### Production Example of Water-Dispersible Acrylic Pressure-Sensitive Adhesive Composition

A water-dispersible acrylic pressure-sensitive adhesive composition (hereinafter also referred to as “PSA 7”) was prepared by the procedure of Production Example 11, except for using, as a compound (B) instead of “ADEKA Pluronic 25R-1”, 0.5 part by weight of “ADEKA Pluronic 17R-3” as indicated in Table 2.

### Production Example 14

### Production Example of Water-Dispersible Acrylic Pressure-Sensitive Adhesive Composition

A water-dispersible acrylic pressure-sensitive adhesive composition (hereinafter also referred to as “PSA 8”) was prepared by the procedure of Production Example 7, except for using, as a compound (B) instead of “ADEKA Pluronic 25R-1”, 0.5 part by weight of PPO-PEO-PPO [trade name “Poly(propylene glycol)-block-poly(ethylene glycol)-block-poly(propylene glycol)” supplied by SIGMA-ALDRICH Co., LLC., number-average molecular weight: 2000, EO content: 50 percent by weight]; and using 3 parts by weight of “TETRAD-X” as a water-insoluble crosslinking agent (C) instead of “TETRAD-C”, as indicated in Table 2.

### Production Example 15

### Production Example of Water-Dispersible Acrylic Pressure-Sensitive Adhesive Composition

A water-dispersible acrylic pressure-sensitive adhesive composition (hereinafter also referred to as “PSA 9”) was prepared by the procedure of Production Example 7, except for using neither copolymer as a compound (B) nor acetylenic diol compound, as indicated in Table 2.

### Production Example 16

### Production Example of Water-Dispersible Acrylic Pressure-Sensitive Adhesive Composition

A water-dispersible acrylic pressure-sensitive adhesive composition (hereinafter also referred to as “PSA 10”) was prepared by the procedure of Production Example 7, except for using, instead of the copolymer serving as a compound (B), 0.5 part by weight of a compound (“POLYRan (EO-PO)”) other than the compound (B), as indicated in Table 2.

### Production Example 17

### Production Example of Water-Dispersible Acrylic Pressure-Sensitive Adhesive Composition

A water-dispersible acrylic pressure-sensitive adhesive composition (hereinafter also referred to as “PSA 11”) was prepared by the procedure of Production Example 7, except for using, instead of the copolymer serving as a compound (B), 3.0 parts by weight of a compound (“PEO-PPO-PEO”) other than the compound (B), as indicated in Table 2.

### Production Example 18

### Production Example of Water-Dispersible Acrylic Pressure-Sensitive Adhesive Composition

A water-dispersible acrylic pressure-sensitive adhesive composition (hereinafter also referred to as “PSA 12”) was prepared by the procedure of Production Example 7, except for using “ADEKA Pluronic 25R-1” as a compound (B) in an amount of 0.1 part by weight per 100 parts by weight of solid components in the acrylic emulsion polymer.

### Production Example 19

### Production Example of Water-Dispersible Acrylic Pressure-Sensitive Adhesive Composition

A water-dispersible acrylic pressure-sensitive adhesive composition (hereinafter also referred to as “PSA 13”) was prepared by the procedure of Production Example 7, except for using no copolymer serving as a compound (B); and using 1.0 part by weight of an acetylenic diol compound having a HLB value of 13 or more (“Surfynol 465”) instead of the acetylenic diol compound having a HLB value of less than 13 (acetylenic diol compound (C)).

Table 2 indicates formulations of the above-prepared water-dispersible acrylic pressure-sensitive adhesive compositions (PSAs 1 to 13).

### Example 1

The above-prepared water-dispersible acrylic pressure-sensitive adhesive composition (PSA 1) was applied to a surface of the above-prepared transparent film substrate (SUB 1) opposite to the top coat layer using an applicator (supplied by TESTER SANGYO CO., LTD.) to a dry thickness of 15 μm and dried in an oven with internal air circulation at 120° C. for 2 minutes. To a PET film having a surface treated with a silicone (“MRF38” supplied by Mitsubishi Plastics, Inc.), was laminated the dried pressure-sensitive adhesive layer on the silicone-treated surface, aged at 50° C. for 3 days, and yielded a pressure-sensitive adhesive sheet as indicated in Table 3.

### Examples 2 to 12 and Comparative Examples 1 to 7

Pressure-sensitive adhesive sheets were prepared by the procedure of Example 1, except for using a water-dispersible acrylic pressure-sensitive adhesive composition of different type and/or a transparent film substrate of different type, as indicated in Table 3.

The product under trade name of “Diafoil T100G” (supplied by Mitsubishi Chemical Corporation) used as a substrate in Comparative Example 7 was a PET film having an antistatic layer on one side thereof (antistatically treated PET film). The antistatic layer contained a compound containing an ammonium base as an antistatic agent.

Evaluations

The above-prepared transparent film substrates, and the pressure-sensitive adhesive sheets obtained in Examples and Comparative Examples were evaluated according to measurement methods or evaluation methods as mentioned below. The solvent-insoluble content and the solvent-soluble fraction weight-average molecular weight of the acrylic emulsion polymer, and the solvent-insoluble content of the acrylic pressure-sensitive adhesive layer (after crosslinking) were measured by the aforementioned measurement methods.

Evaluation data are indicated in Tables 1 to 3.

(1) Top Coat Layer Thickness (Average Thickness and Thickness Variation)

The top coat layer thickness was measured by observing a cross section of each of the transparent film substrates prepared in Production Examples with a transmission electron microscope (TEM).

Independently, the peak intensities of sulfur atom (derived from PEDT and PSS contained in the top coat layer) were measured in the top coat layer surface of each transparent film substrate with an X-ray fluorescence analyzer (XRF analyzer, Model “ZSX-100e” supplied by Rigaku Corporation). The X-ray fluorescence analysis was performed under conditions as follows:

X-ray Fluorescence Analysis

Instrument: XRF analyzer, Model “ZSX-100e” supplied by Rigaku Corporation

X-ray source: vertical Rh tube

Analysis range: within a circle of 30 mm diameter

Detected X-ray: S-Kα

Dispersive crystal: Ge crystal

Output: 50 kV, 70 mA

Based on the top coat layer thickness (the measured value) obtained by TEM observation and the data of the X-ray fluorescence analysis, a calibration curve was plotted to derive the top coat layer thickness from peak intensities observed in the X-ray fluorescence analysis.

The top coat layer thickness of each transparent film substrate was measured using the calibration curve. Specifically, X-ray fluorescence analysis was performed starting from one end of the width through the other end at ⅙, 2/6, 3/6, 4/6, and ⅚ the width along a straight line across the width (in a direction perpendicular to the bar coater's moving direction) of the area bearing the top coat layer. Based on the obtained data (sulfur atom X-ray intensities (kcps)) together with the top coat layer formulation (the content of PEDT and PSS) and the calibration curve, were determined the thicknesses of the top coat layer at the respective five measurement points. The average thickness Dₐᵥₑ was determined by averaging the top coat layer thickness values at the five measurement points. The thickness variation ΔD was calculated by substituting the average thickness Dₐᵥₑ, the maximum value Dₘₐₓ and the minimum value Dₘᵢₙ of the top coat layer thickness values at the five measurement points into an equation as follows: ΔD=(Dₘₐₓ−Dₘᵢₙ)/Dₐᵥₑ×100(%).

(2) X-Ray Intensity Variation in Top Coat Layer Surface

The average X-ray intensity Iₐᵥₑ was determined by averaging the sulfur atom X-ray intensities (kcps) obtained at the respective locations (the five measurement points) by the X-ray fluorescence analysis. In addition, the X-ray intensity variation ΔI was calculated by substituting the average X-ray intensity Iₐᵥₑ, the maximum value Iₘₐₓ and the minimum value Iₘᵢₙ of the X-ray intensities at the respective locations (the five measurement points) into an equation as follows: ΔI=(Iₘₐₓ−Iₘᵢₙ)/Iₐᵥₑ×100(%).

(3) Transparent Film Substrate Appearance

The backside (top coat layer side surface) of each of the transparent film substrates (SUBs 1 to 6) was visually observed in a bright room having a window admitting the outside light. The observation was performed beside the window where no direct sunlight was got during the daytime on a sunny day. Based on the observed results, the appearance of each transparent film substrate was evaluated according to criteria as follows:

Good (G; good appearance): neither unevenness nor streaks were observed.

Poor (P; poor appearance): unevenness and/or streaks were observed.

(4) Top Coat Layer Surface Resistivity

The surface resistance Rs of the top coat layer side surface of each of the above-prepared transparent film substrates (SUBs 1 to 6) was measured according to JIS K6911 using an insulation resistance tester (trade name “Hiresta-up MCP-HT450” supplied by Mitsubishi Chemical Analytech Co., Ltd.) at an ambient temperature of 23° C. and relative humidity of 55%. A voltage of 100 V was applied, and the surface resistance Rs was read 60 seconds into the measurement. Based on the results, the surface resistivity was calculated according to an equation as follows:

ρs=Rs×E/V×π(D+d)/(D−d)

wherein ρs represents the surface resistivity (Ω/square), Rs represents the surface resistance (Ω); E represents the applied voltage (V); V represents the measured voltage (V); D represents the inner diameter (cm) of the ring portion of the surface electrode; and d represents the outer diameter (cm) of the inner circular portion of the surface electrode.

(5) Top Coat Layer Surface Scratch Resistance

A sample of 10 cm² (10 cm wide by 10 cm long) was cut out from each of the above-prepared transparent film substrates (SUBs 1 to 6). An examiner scratched the backside (top coat layer side surface) of the sample by fingernails in a room (bright room) having a window admitting outside light, and the scratch resistance was evaluated by whether or not the sample was scratched by the fingernails. Specifically, the backside of the sample after being scratched by the fingernails was observed with an optical microscope. A sample where debris scraped off from the top coat layer was observed was evaluated as poor (P) (poor scratch resistance); whereas a sample where no debris was observed was evaluated as good (G) (good scratch resistance).

(6) Resistance to Adhesive Strength Increase

Initial Adhesive Strength

Each of the pressure-sensitive adhesive sheets obtained in Examples and Comparative Examples (sample size: 25 mm wide by 100 mm long) was laminated onto a polarizing plate using a laminator (compact laminator supplied by TESTER SANGYO CO., LTD.) at 0.25 MPa and 0.3 m/min. The polarizing plate was made from a triacetyl cellulose (TAC) and had an arithmetic mean surface roughness Ra of about 21 nm in the machine direction (MD), about 31 nm in the transverse direction (TD), and about 26 nm on an average of the machine direction (MD) and the transverse direction (TD).

The laminated sample including the pressure-sensitive adhesive sheet and the polarizing plate was left stand at an ambient temperature of 23° C. and relative humidity of 50% for 20 minutes, subjected to a 180-degree peel test under conditions mentioned below to measure an adhesive strength (N/25 mm) of the pressure-sensitive adhesive sheet to the polarizing plate, and the measured adhesive strength was defined as an “initial adhesive strength.”

Adhesive Strength after One-Week Application/Storage at 40° C.

Each of the pressure-sensitive adhesive sheets obtained in Examples and Comparative Examples (sample size: 25 mm wide by 100 mm long) was laminated onto a polarizing plate using a laminator (compact laminator supplied by TESTER SANGYO CO., LTD.) at 0.25 MPa and 0.3 m/min. The polarizing plate was made from a triacetyl cellulose (TAC) and had an arithmetic mean surface roughness Ra of about 21 nm in the machine direction (MD), about 31 nm in the transverse direction (TD), and about 26 nm on an average of the machine direction (MD) and the transverse direction (TD).

The laminated sample including the pressure-sensitive adhesive sheet and the polarizing plate was stored at an ambient temperature of 40° C. for one week, left stand at an ambient temperature of 23° C. and relative humidity of 50% for 2 hours, subjected to a 180-degree peel test under conditions mentioned below to measure an adhesive strength (N/25 mm) of the pressure-sensitive adhesive sheet to the polarizing plate was measured and defined as an “adhesive strength after one-week application/storage at 40° C.”

The 180-degree peel test was performed with a tensile tester at an ambient temperature of 23° C. and relative humidity of 50% and at a tensile speed of 0.3 m/min.

A sample having a difference between the initial adhesive strength and the adhesive strength after one-week application/storage at 40° C. [(adhesive strength after one-week application/storage at 40° C.)−(initial adhesive strength)] of 0.10 N/25 mm or less could be determined as having satisfactory resistance to adhesive strength increase.

(7) Cloudiness (Clouding Resistance) of Pressure-Sensitive Adhesive Sheet Upon Storage Under Humid Conditions

Each of the pressure-sensitive adhesive sheets obtained in Examples and Comparative Examples was left stand at an ambient temperature of 50° C. and relative humidity of 95% for 24 hours (stored under humid conditions), and the haze of which was then measured with “DIGITAL HAZEMETER NDH-20D” supplied by Nippon Denshoku Industries Co., Ltd. The haze was defined as a “haze after storage under humid conditions.” The measurement was performed within 3 minutes after the sample was retrieved from the environment at a temperature of 50° C. and relative humidity of 95%. As a comparison, the haze of the sample before storage under humid conditions was also measured and defined as a “haze before storage under humid conditions.”

(8) Pressure-Sensitive Adhesive Sheet Appearance (Visual Quality)

The acrylic pressure-sensitive adhesive layer surface of each of the pressure-sensitive adhesive sheets obtained in Examples and Comparative Examples was visually observed. Defects (dimples and bubbles) were counted in an observation area of 10 cm long by 10 cm wide. The appearance (visual quality) of each pressure-sensitive adhesive sheet was synthetically evaluated together with the evaluation data of the transparent film substrate appearance, according to criteria as follows.

Poor appearance (P) of the pressure-sensitive adhesive sheet: the transparent film substrate had a poor appearance, or the number of defects was 101 or more although the transparent film substrate had a good appearance;

Good appearance (G) of the pressure-sensitive adhesive sheet: the transparent film substrate had a good appearance, and the number of defects was from 0 to 100.

(9) Less-Staining Properties (Suppression of Clouding as Stain) [Test under Humid Conditions]

Each of the pressure-sensitive adhesive sheets prepared in Examples and Comparative Examples (sample size: 25 mm wide by 100 mm long) was laminated onto a polarizing plate (trade name “SEG1425DUHC” supplied by Nitto Denko Corporation, 70 mm wide by 120 mm long) at 0.25 MPa and 0.3 m/min using a laminator (compact laminator supplied by Tester Sangyo Co., Ltd.).

The polarizing plate with the pressure-sensitive adhesive sheet was left stand at 80° C. for 4 hours, and then the pressure-sensitive adhesive sheet was removed therefrom. The polarizing plate, from which the pressure-sensitive adhesive sheet had been removed, was left stand in an environment under humid conditions (at a temperature of 23° C. and relative humidity of 90%) for 12 hours, the surface of which was visually observed, and less-staining properties were evaluated according to criteria as follows:

Satisfactorily less staining (G): no change was observed both in a region where the pressure-sensitive adhesive sheet had been laminated and in a region where the pressure-sensitive adhesive sheet had not been laminated.

Staining (P): clouding was observed in a region where the pressure-sensitive adhesive sheet had been laminated.

TABLE 1

| | | SUB 1 | SUB 2 | SUB 3 | SUB 4 | SUB 5 | SUB 6 |
|---|---|---|---|---|---|---|---|
| Top coat layer | Binder Solution 1 (g) | 2 | 2 | 2 | 2 | — | — |
| coating | Binder Solution 2 (g) | — | — | — | — | 5.5 | — |
| composition | Binder Solution 3 (g) | — | — | — | — | — | 2 |
| formulation | Ethylene glycol monoethyl ether (g) | 40 | 40 | 19 | 15 | 30 | 40 |
| | Electroconductive Polymer Solution 1 (g) | 1.2 | 2.5 | 0.7 | 0.7 | — | 1.2 |
| | Electroconductive Polymer Solution 2 (g) | — | — | — | — | 14 | — |
| | Ethylene glycol monomethyl ether (g) | 55 | 17 | — | — | 6 | 55 |
| | Lubricant solution (g) | 0.05 | 0.05 | 0.05 | 0.05 | 0.5 | 0.05 |
| | Melamine crosslinking agent (g) | 0.02 | 0.02 | 0.02 | 0.02 | — | 0.02 |
| NV (percent by weight) of Top coat layer coating composition | | 0.2 | 0.4 | 0.8 | 1.0 | 4.9 | 0.2 |
| Top coat layer | Binder Polymer 1 (part by weight) [copolymerization | 100 | 100 | 100 | 100 | — | — |
| | composition: MMA/BA/CHMA = 30/10/5] | | | | | | |
| | Binder Polymer 2 (part by weight) [copolymerization | — | — | — | — | 100 | — |
| | composition: MMA/BA/MAA/CHMA = 32/5/0.7/5] | | | | | | |
| | Binder Polymer 3 (part by weight) [copolymerization | — | — | — | — | — | 100 |
| | composition: MMA/BA/CHMA/HEMA = 30/10/5/5] | | | | | | |
| | Polythiophene and PSS (part by weight) | 48 | 100 | 28 | 28 | 8 | 48 |
| | Lubricant (part by weight) | 26 | 26 | 26 | 26 | 11 | 26 |
| | Melamine crosslinking agent (part by weight) | 20 | 20 | 20 | 20 | — | 20 |
| Evaluation data of | Average thickness Dₐᵥₑ (nm) of top coat layer | 7.8 | 18.9 | 34.6 | 51.2 | 612.4 | 8.2 |
| transparent film | Thickness variation ΔD (%) of top coat layer | 15.8 | 34.4 | 12.5 | 34.4 | 52.7 | 15.5 |
| substrate | Average X-ray intensity Iₐᵥₑ (kcps) of top coat layer | 0.43 | 2.07 | 1.13 | 1.68 | 5.35 | 0.45 |
| | X-ray variation ΔI (%) of top coat layer | 15.8 | 34.4 | 12.5 | 34.4 | 52.7 | 15.5 |

TABLE 2

| | | | PSA | PSA | PSA | PSA | PSA | PSA | PSA | PSA | PSA | PSA | PSA | PSA | PSA |
|---|---|---|---|---|---|---|---|---|---|---|---|---|---|---|---|
| | | | 1 | 2 | 3 | 4 | 5 | 6 | 7 | 8 | 9 | 10 | 11 | 12 | 13 |
| Acrylic | Constitutive monomer | 2EHA | 96 | 96 | 96 | 96 | 96 | 92 | 96 | 96 | 96 | 96 | 96 | 96 | 96 |
| emulsion | (part by weight) | MMA | — | — | — | — | — | 4 | — | — | — | — | — | — | — |
| polymer | | AA | 4 | 4 | 4 | 4 | 4 | 4 | 4 | 4 | 4 | 4 | 4 | 4 | 4 |
| (A) | Emulsifier (part by | HS-10 | 3 | 3 | 3 | 3 | — | 3 | — | 3 | 3 | 3 | 3 | 3 | 3 |
| | weight | SE-10N | — | — | — | — | 3 | — | 3 | — | — | — | — | — | — |
| | Solvent-insoluble content (percent by | | 83 | 83 | 83 | 83 | 85 | 85 | 85 | 83 | 83 | 83 | 83 | 83 | 83 |
| | weight) | | | | | | | | | | | | | | |
| | Weight-average molecular weight of | | 8 × | 8 × | 8 × | 8 × | 9 × | 9 × | 9 × | 8 × | 8 × | 8 × | 8 × | 8 × | 8 × |
| | solvent-soluble fraction | | 10⁴ | 10⁴ | 10⁴ | 10⁴ | 10⁴ | 10⁴ | 10⁴ | 10⁴ | 10⁴ | 10⁴ | 10⁴ | 10⁴ | 10⁴ |
| Water- | Acrylic emulsion polymer (A) (part by | | 100 | 100 | 100 | 100 | 100 | 100 | 100 | 100 | 100 | 100 | 100 | 100 | 100 |
| dispersible | weight) | | | | | | | | | | | | | | |
| acrylic | Water-insoluble cross- | TETRAD C | 3 | 3 | 3 | 3 | 3 | 3 | 3 | — | 3 | 3 | 3 | 3 | 3 |
| pressure- | linking agent (part by | TETRAD X | — | — | — | — | — | — | — | 3 | — | — | — | — | — |
| sensitive | weight) | | | | | | | | | | | | | | |
| adhesive | Ratio (molar ratio) of number of moles | | 0.5 | 0.5 | 0.5 | 0.5 | 0.5 | 0.5 | 0.5 | 0.5 | 0.5 | 0.5 | 0.5 | 0.5 | 0.5 |
| composi- | of epoxy group (glycidyl amino group) | | | | | | | | | | | | | | |
| tion | to number of moles of carboxyl group | | | | | | | | | | | | | | |
| | Compound (B) (part by | ADEKA | 1.0 | 1.0 | 1.0 | 1.0 | 1.0 | 1.0 | — | — | — | — | — | 0.1 | — |
| | weight) | Pluronic | | | | | | | | | | | | | |
| | | 25R-1 | | | | | | | | | | | | | |
| | | ADEKA | — | — | — | — | — | — | 0.5 | — | — | — | — | — | — |
| | | Pluronic | | | | | | | | | | | | | |
| | | 17R-3 | | | | | | | | | | | | | |
| | | PPO-PEO- | — | — | — | — | — | — | — | 0.5 | — | — | — | — | — |
| | | PPO | | | | | | | | | | | | | |
| | Compound other than | POLYRan | — | — | — | — | — | — | — | — | — | 0.5 | — | — | — |
| | Compound | (EO-PO) | | | | | | | | | | | | | |
| | (B) (part by weight) | PEO-PPO- | — | — | — | — | — | — | — | — | — | — | 3.0 | — | — |
| | | PEO | | | | | | | | | | | | | |
| | Acetylenic diol compound | Surfynol 104H | 1.0 | — | — | — | 1.0 | 1.0 | 1.0 | 1.0 | — | 1.0 | 1.0 | 1.0 | — |
| | having HLB of less | (HLB = 4) | | | | | | | | | | | | | |
| | than 13 (part by weight) | Surfynol | — | 1.0 | — | — | — | — | — | — | — | — | — | — | — |
| | | 104PG-50 | | | | | | | | | | | | | |
| | | (HLB = 4) | | | | | | | | | | | | | |
| | | Surfynol 420 | — | — | 1.0 | — | — | — | — | — | — | — | — | — | — |
| | | (HLB = 4) | | | | | | | | | | | | | |
| | | Surfynol 440 | — | — | — | 1.0 | — | — | — | — | — | — | — | — | — |
| | | (HLB = 8) | | | | | | | | | | | | | |
| | Acetylenic diol compound | Surfynol 465 | — | — | — | — | — | — | — | — | — | — | — | — | 1.0 |
| | having HLB of 13 or | (HLB = 13) | | | | | | | | | | | | | |
| | more (part by weight) | | | | | | | | | | | | | | |

TABLE 3

| | | | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|---|
| | | | 1 | 2 | 3 | 4 | 5 | 6 | 7 | 8 | 9 | 10 | 11 | 12 |
| Sheet | Water-dispersible acrylic pressure- | | PSA | PSA | PSA | PSA | PSA | PSA | PSA | PSA | PSA | PSA | PSA | PSA |
| structure | sensitive composition | | 1 | 2 | 3 | 4 | 5 | 6 | 7 | 8 | 1 | 1 | 12 | 1 |
| | Transparent film substrate | | SUB | SUB | SUB | SUB | SUB | SUB | SUB | SUB | SUB | SUB | SUB | SUB |
| | | | 1 | 1 | 1 | 1 | 1 | 1 | 1 | 1 | 2 | 3 | 1 | 6 |
| Evaluation | Solvent-insoluble content (percent | | 95 | 95 | 95 | 95 | 95 | 95 | 96 | 96 | 95 | 95 | 96 | 95 |
| data | by weight) in acrylic pressure- | | | | | | | | | | | | | |
| | sensitive adhesive layer (after | | | | | | | | | | | | | |
| | crosslinking) | | | | | | | | | | | | | |
| | Resistance to | Initial adhesive | 0.06 | 0.06 | 0.06 | 0.06 | 0.06 | 0.06 | 0.07 | 0.07 | 0.06 | 0.06 | 0.09 | 0.06 |
| | adhesive | strength | | | | | | | | | | | | |
| | strength | (N/25 mm) | | | | | | | | | | | | |
| | increase | Adhesive strength | 0.07 | 0.07 | 0.07 | 0.07 | 0.08 | 0.07 | 0.09 | 0.09 | 0.07 | 0.08 | 0.10 | 0.07 |
| | | (N/25 mm) after | | | | | | | | | | | | |
| | | one-week applica- | | | | | | | | | | | | |
| | | tion/storage at | | | | | | | | | | | | |
| | | 40° C. | | | | | | | | | | | | |
| | Clouding | Haze (%) before storage | 2.4 | 2.4 | 2.4 | 2.4 | 2.4 | 2.4 | 2.4 | 2.4 | 2.4 | 2.4 | 2.4 | 2.4 |
| | resistance | under humid conditions | | | | | | | | | | | | |
| | | Haze (%) after storage | 2.5 | 2.5 | 2.5 | 2.5 | 2.6 | 2.5 | 2.6 | 2.6 | 2.5 | 2.5 | 2.5 | 2.5 |
| | | under humid conditions | | | | | | | | | | | | |

| | | | | | | | | | | | | |
|---|---|---|---|---|---|---|---|---|---|---|---|---|
| Pressure-sensitive adhesive | G | G | G | G | G | G | G | G | G | G | G | G |
| sheet appearance | | | | | | | | | | | | |
| Less-staining properties | G | G | G | G | G | G | G | G | G | G | G | G |
| Transparent film substrate appearance | G | G | G | G | G | G | G | G | G | G | G | G |
| Surface resistivity (Ω/square) | 4.3 × | 4.3 × | 4.3 × | 4.3 × | 4.3 × | 4.3 × | 4.3 × | 4.3 × | 3.3 × | 4.5 × | 4.3 × | 4.7 × |
| | 10⁹ | 10⁹ | 10⁹ | 10⁹ | 10⁹ | 10⁹ | 10⁹ | 10⁹ | 10⁸ | 10⁹ | 10⁹ | 10⁹ |
| Scratch resistance | G | G | G | G | G | G | G | G | G | G | G | G |

| | | Com. | Com. | Com. | Com. | Com. | Com. | Com. |
|---|---|---|---|---|---|---|---|---|
| | | Ex. 1 | Ex. 2 | Ex. 3 | Ex. 4 | Ex. 5 | Ex. 6 | Ex. 7 |
| Sheet | Water-dispersible acrylic pressure- | PSA | PSA | PSA | PSA | PSA | PSA | PSA |
| structure | sensitive composition | 9 | 10 | 11 | 13 | 1 | 1 | 1 |
| | Transparent film substrate | SUB | SUB | SUB | SUB | SUB | SUB | T100G |
| | | 1 | 1 | 1 | 1 | 4 | 5 | |
| Evaluation | Solvent-insoluble content (percent | 97 | 95 | 93 | 95 | 95 | 95 | 95 |
| data | by weight) in acrylic pressure- | | | | | | | |
| | sensitive adhesive layer (after | | | | | | | |
| | crosslinking) | | | | | | | |

| | | | | | | | | |
|---|---|---|---|---|---|---|---|---|
| Resistance to | Initial adhesive | —(*1) | —(*1) | 0.03 | 0.02 | 0.06 | 0.06 | 0.06 |
| adhesive | strength | | | | | | | |
| strength | (N/25 mm) | | | | | | | |
| increase | Adhesive strength | —(*1) | —(*1) | 0.03 | 0.07 | 0.07 | 0.07 | 0.07 |
| | (N/25 mm) after | | | | | | | |
| | one-week applica- | | | | | | | |
| | tion/storage at | | | | | | | |
| | 40° C. | | | | | | | |
| Clouding | Haze (%) before storage | 3.4 | 5.4 | 17.2 | 2.4 | —(*3) | —(*3) | 2.1 |
| resistance | under humid conditions | | | | | | | |
| | Haze (%) after storage | 3.6 | 8.1 | —(*2) | 4.9 | —(*3) | —(*3) | 3.7 |
| | under humid conditions | | | | | | | |

| | | | | | | | |
|---|---|---|---|---|---|---|---|
| Pressure-sensitive adhesive | P | P | P | P | P | P | G |
| sheet appearance | | | | | | | |
| Less-staining properties | G | P | P | P | G | G | G |
| Transparent film substrate appearance | G | G | G | G | P | P | G |
| Surface resistivity (Ω/square) | 4.3 × | 4.3 × | 4.3 × | 4.3 × | 8.9 × | 2.1 × | 2.1 × |
| | 10⁹ | 10⁹ | 10⁹ | 10⁹ | 10⁸ | 10⁷ | 10⁹ |
| Scratch resistance | G | G | G | G | G | P | P |

(*1)No measurement was performed due to poor appearance of the pressure-sensitive adhesive sheet.
(*2)No measurement was performed due to high initial haze (haze before storage in humid conditions).
(*3)No measurement was performed due to poor appearance of the substrate

The abbreviations used in Tables 2 and 3 refer to as follows:

Hereinafter the ratio of the “total weight of EO(s)” to the total weight of the compound(s) (B)” is indicated as the “EO content.”

Constitutive Monomers

2EHA: 2-ethylhexyl acrylate

MMA: methyl methacrylate

AA: acrylic acid

Emulsifier

HS-10: trade name “AQUALON HS-10” (nonionic-anionic reactive emulsifier) supplied by Dai-ichi Kogyo Seiyaku Co., Ltd.

SE-10N: trade name “ADEKA REASOAP SE-10N” (nonionic-anionic reactive emulsifier) supplied by ADEKA CORPORATION

Crosslinking Agent

TETRAD C: trade name “TETRAD-C” (1,3-bis(N,N-diglycidylaminomethyl)cyclohexane, epoxy equivalent: 110, number of functional groups: 4) supplied by MITSUBISHI GAS CHEMICAL COMPANY, INC.

TETRAD X: trade name “TETRAD-X” (1,3-bis(N,N-diglycidylaminomethyl)benzene, epoxy equivalent: 100, number of functional groups: 4) supplied by MITSUBISHI GAS CHEMICAL COMPANY, INC.

Compound (B)

ADEKA Pluronic 25R-1: trade name “ADEKA Pluronic 25R-1” (number-average molecular weight: 2800, EO content: 10 percent by weight, active ingredient: 100 percent by weight) supplied by ADEKA CORPORATION

ADEKA Pluronic 17R-3: trade name “ADEKA Pluronic 17R-3” (number-average molecular weight: 2000, EO content: 30 percent by weight, active ingredient: 100 percent by weight) supplied by ADEKA CORPORATION

PPO-PEO-PPO: Poly(propylene glycol)-block-poly(ethylene glycol)-block-poly(propylene glycol) (number-average molecular weight: 2000, EO content: 50 percent by weight, active ingredient: 100 percent by weight) supplied by SIGMA-ALDRICH Co., LLC.

Compound Other than Compound (B)

POLYRan (EO-PO): Poly(ethylene glycol-ran-propylene glycol) (number-average molecular weight: 2500, EO content: 75 percent by weight, active ingredient: 100 percent by weight) supplied by SIGMA-ALDRICH Co., LLC.

PEO-PPO-PEO: Poly(ethylene glycol)-block-poly(propylene glycol)-block-poly(ethylene glycol) (number-average molecular weight: 1900, EO content: 50 percent by weight, active ingredient: 100 percent by weight) supplied by SIGMA-ALDRICH Co., LLC.

Acetylenic Diol Compound

Surfynol 104H: trade name “Surfynol 104H” (HLB value: 4, active ingredient: 75 percent by weight) supplied by Air Products and Chemicals Inc.

Surfynol 104PG-50: trade name “Surfynol 104PG-50” (HLB value: 4, active ingredient: 50 percent by weight) supplied by Air Products and Chemicals Inc.

Surfynol 420: trade name “Surfynol 420” (HLB value: 4, active ingredient: 100 percent by weight) supplied by Air Products and Chemicals Inc.

Surfynol 440: trade name “Surfynol 440” (HLB value: 8, active ingredient: 100 percent by weight) supplied by Air Products and Chemicals Inc.,

Surfynol 465: trade name “Surfynol 465” (HLB value: 13, active ingredient: 100 percent by weight) supplied by Air Products and Chemicals Inc.

Substrate (Transparent Film Substrate)

T100G: antistatically treated PET film, trade name “Diafoil T100G” supplied by Mitsubishi Chemical Corporation

The data in Table 3 demonstrate as follows. The pressure-sensitive adhesive sheets according to Examples satisfied conditions specified in the present invention. They had a good appearance, less increased in adhesive strength with time after the application, and satisfactorily less caused stains. They were highly resistant to static electrification and scratches and did not appear cloudy even when stored under humid conditions.

By contrast, Comparative Examples 1 to 4 did not employ a compound (B) and/or an acetylenic diol compound; and Comparative Examples 5 and 6 had an average thickness and/or a thickness variation in the top coat layer of the substrate not satisfying the conditions specified in the present invention. The pressure-sensitive adhesive sheets according to these comparative examples each had a poor appearance. Comparative Examples 2 and 3 employed, instead of a compound (B), a compound other than the compound (B); and Comparative Example 4 employed an acetylenic diol compound having a HLB value of 13 or more. The pressure-sensitive adhesive sheets according to these comparative examples caused clouding as stain on the adherend in a high-humidity environment. Among them, Comparative Example 6 employed no melamine crosslinking agent as a component to form the top coat layer; and the pressure-sensitive adhesive sheet according to this comparative example was also inferior in scratch resistance. Comparative Example 2 employed a compound other than the compound (B); and Comparative Example 4 employed an acetylenic diol compound having a HLB value of 13 or more. The pressure-sensitive adhesive sheets according to these comparative examples had a highly increased haze and appeared cloudy through storage under humid conditions. Comparative Example 7 employed an antistatic layer of the substrate not being a top coat layer including a polythiophene, an acrylic resin, and a melamine crosslinking agent, but an antistatic layer using an hygroscopic antistatic agent instead of the polythiophene. The pressure-sensitive adhesive sheet according to this comparative example had a haze increased through storage under humid conditions and had poor scratch resistance.

### INDUSTRIAL APPLICABILITY

The pressure-sensitive adhesive sheets according to embodiments of the present invention are usable in applications where they will be removed. They are advantageously usable particularly for the surface protection of optical members (e.g., optical plastics, optical glass, and optical films) typically as a surface-protecting film for an optical member. The optical members are exemplified by polarizing plates, retardation films, anti-reflective films, wave plates, compensation films, and brightness enhancing films each constituting panels such as liquid crystal displays, organic electroluminescence (organic EL) displays, and field emission displays. The pressure-sensitive adhesive sheets according to the present invention are also usable typically for surface-protection, failure-prevention, removal of foreign matter, or masking upon production of microfabricated components such as semiconductors (semiconductor devices), circuits, printed circuit boards, masks, and lead frames.

1. A pressure-sensitive adhesive sheet comprising:
a transparent film substrate; and an acrylic pressure-sensitive adhesive layer present on or over at least one side of the transparent film substrate,
wherein:
the transparent film substrate comprises a base layer formed from a resinous material, and a top coat layer present on or above a first face of the base layer;
the top coat layer comprises a polythiophene, an acrylic resin, and a melamine crosslinking agent and has an average thickness Dₐᵥₑ of from 2 to 50 nm and a thickness variation ΔD of 40% or less;
the acrylic pressure-sensitive adhesive layer is formed from a water-dispersible removable acrylic pressure-sensitive adhesive composition, where the water-dispersible removable acrylic pressure-sensitive adhesive composition comprises: an acrylic emulsion polymer (A); a compound (B) represented by Formula (I); and an acetylenic diol compound (C) having a HLB value of less than 13;
the acrylic emulsion polymer (A) is derived from constitutive monomers comprising a (meth)acrylic alkyl ester and a carboxyl-containing unsaturated monomer as essential constitutive monomers, where the constitutive monomers comprise the (meth)acrylic alkyl ester in a content of from 70 to 99.5 percent by weight and the carboxyl-containing unsaturated monomer in a content of from 0.5 to 10 percent by weight based on the total amount of the entire constitutive monomers; and
the acrylic emulsion polymer (A) is polymerized with a reactive emulsifier containing at least one radically polymerizable functional group per molecule,
Formula (I) expressed as follows:
R^{a}O—(PO)ₗ-(EO)ₘ—(PO)ₙ—R^{b} (I)
wherein each of R^{a} and R^{b} independently represents a straight or branched chain alkyl group or hydrogen atom; PO represents oxypropylene group; EO represents oxyethylene group; and each of l, m, and n independently denotes a positive integer, where EO(s) and POs are added in a block manner.

2. The pressure-sensitive adhesive sheet according to claim 1, wherein the resinous material constituting the base layer comprises a poly(ethylene terephthalate) or a poly(ethylene naphthalate) as a principal resinous component.

3. The pressure-sensitive adhesive sheet according to one of claims 1, wherein the water-dispersible removable acrylic pressure-sensitive adhesive composition further comprises a water-insoluble crosslinking agent (D) having two or more carboxyl-reactive functional groups per molecule, the carboxyl-reactive functional groups capable of reacting with carboxyl group.

4. The pressure-sensitive adhesive sheet according to claim 1, as a surface-protecting film for an optical member.

5. The pressure-sensitive adhesive sheet according to one of claims 2, wherein the water-dispersible removable acrylic pressure-sensitive adhesive composition further comprises a water-insoluble crosslinking agent (D) having two or more carboxyl-reactive functional groups per molecule, the carboxyl-reactive functional groups capable of reacting with carboxyl group.

6. The pressure-sensitive adhesive sheet according to claim 2, as a surface-protecting film for an optical member.

7. The pressure-sensitive adhesive sheet according to claim 3, as a surface-protecting film for an optical member.

8. The pressure-sensitive adhesive sheet according to claim 5, as a surface-protecting film for an optical member.
